(19) United States
(12) Patent Application Publication
(10) Pub. No.: US 2026/0226694 A1
(43) Pub. Date: Aug. 6, 2026

(54) DRAWING DEVICE FOR PERSONAL TRANSPORTATION VEHICLE

(71) Applicant: Razor USA LLC, Cerritos, CA (US)

(72) Inventor: Ian Desberg, Cerritos, CA (US)

(21) Appl. No.: 19/467,446

(22) Filed: Feb. 2, 2026

Related U.S. Application Data
(60) Provisional application No. 63/753,782, filed on Feb. 4, 2025.
(60) Provisional application No. 63/809,895, filed on May 21, 2025.

(51) Int. Cl. E01C 23/20

(52) U.S. Cl. CPC E01C 23/203

(57) ABSTRACT

Various drawing devices are disclosed. The drawing devices can be utilized with personal transportation vehicles such as a drifting cart. The drawing device can be coupled to a wheel assembly of the vehicle, which can include a caster wheel assembly. The drawing device can swivel with the wheel assembly relative to the vehicle. The drawing device can include one or more dispensers to receive a front portion of a marker, such as a chalk stick, and to enable a rear portion of the marker to protrude from the dispenser. The drawing device can rotate about an axle of a wheel of the wheel assembly such that the drawing device can rotate relative to the wheel between a deployed position in which the marker generates markings on a riding surface and a stowed position in which the marker does not generate markings on the riding surface.

### CROSS REFERENCE

This application claims the priority benefit of U.S. Provisional Application No. 63/753,782, filed Feb. 4, 2025 and U.S. Provisional Application No. 63/809,895, filed May 21, 2025, each of which are hereby incorporated by reference in their entireties. All applications for which a foreign or domestic priority is identified in the Application Data Sheet as filed herewith are hereby incorporated by reference under 37 CFR 1.57. Any differences between the priority document(s) and the present document shall not be construed as a disclaimer or disavowal.

### BACKGROUND

This disclosure relates generally to a drawing device, and more specifically to a drawing device for use with a personal transportation device such as a scooter, cart, go-kart, push kart, drifting kart, soapbox car, skateboard, caster board, swivel board, or otherwise.

It can be desirable to draw (e.g., generate markings) on a riding surface when operating a transportation device. For example, a user may wish to draw on a riding surface to trace or approximate the path the transportation device is taking along the riding surface.

### SUMMARY OF CERTAIN FEATURES

The present disclosure relates to drawing devices for use with personal transportation devices, such as scooters, carts, go-karts, push karts, drift karts, cars, soapbox cars, skateboards, caster boards, swivel boards, or otherwise. In particular, the present disclosure relates to drawing devices that can be coupled (e.g., directly or indirectly) to a transportation device to draw on (e.g., mark) a riding surface along which the transportation device moves. In some implementations, the drawing device can be included in (e.g., couple to) one or more wheel assemblies (e.g., caster wheels) of the transportation device which can swivel (e.g., pivot, spin, rotate) with respect to the transportation device, for example, when the transportation device turns and/or drifts. The drawing device can swivel (e.g., pivot, spin, rotate) with the wheel assembly (e.g., as a unit) as the transportation device moves across the riding surface, thereby creating erratic, curved, and/or undulating markings on the riding surface.

In some implementations, the drawing device can hold (e.g., retain, position, dispense) a marker. The marker can be, for example, chalk (e.g., a stick of chalk), a pencil, a pen, a brush, a crayon, or any other device or material suitable for generating markings when in contact with the riding surface. In certain implementations, the markings can be non-transitory, such as a chalk line drawn on pavement. In certain implementations, the markings can be transitory, such as transitory visual markings. In some implementations, the marker can include a sparking material that generates sparks when moved along a riding surface such as concrete, asphalt, stone, brick, etc.

The drawing device can be configured such that a user can choose whether to mark or not to mark. In some implementations, the drawing device can be movable between a deployed position and a stowed position. In the deployed position, the marker can contact the riding surface to provide marking functionality on the riding surface (e.g., as the transportation device moves across the riding surface). In the stowed position, the marker can be spaced from the riding surface to prevent or inhibit marking the riding surface. In some implementations, the drawing device can be rotated (e.g., pivoted) between the deployed and stowed position, for example, about an axis that is generally parallel to and/or generally collinear with an axis of rotation of the wheel assembly. In some implementations, the drawing device can include a lock (e.g., latch) to selectively retain the drawing device in the stowed position, which may prevent or inhibit inadvertent marking of a riding surface.

In some aspects, a drifting cart is disclosed herein. The drifting cart can include a body, a seat on the body, a steerable wheel on a front of the body, and/or a motor configured to drive the steerable wheel. The drifting cart can include a first caster wheel assembly on a rear of the body. The first caster wheel assembly can include a first fork and/or a first rear wheel connected to the first fork. The first rear wheel can swivel about a first swivel axis and rotate about a first rotation axis. The first caster wheel assembly can include a first chalk dispenser connected to the first fork. A first chalk stick can be partially received in the first chalk dispenser. The drifting cart can include a second caster wheel assembly on the rear of the body. The second caster wheel assembly can include a second fork and/or second rear wheel connected to the second fork. The second rear wheel can swivel about a second swivel axis and rotate about a second rotation axis. The second caster wheel assembly can include a second chalk dispenser connected to the second fork. A second chalk stick can be partially received in the second chalk dispenser. The first and second chalk dispensers can each move between a stowed position and a deployed position and/or can be configured such that, during travel of the drifting cart on a riding surface with the first and second chalk dispensers in the deployed position, the first and second chalk sticks mark the riding surface.

In some aspects, the first and second chalk dispensers are independently moveable between the stowed and deployed positions.

In some aspects, the drifting cart further includes a latch configured to releasably retain the first chalk dispenser in the stowed position.

In some aspects, the drifting cart further includes a spring configured to bias the first chalk dispenser toward the deployed position.

In some aspects, with the first chalk dispenser in the deployed position, a front end of the first chalk stick is forward of a rear edge of the first rear wheel and a rear end of the first chalk stick is rearward of the rear edge of the first rear wheel.

In some aspects, a personal mobility vehicle configured to mark a path on a riding surface is disclosed herein. The personal mobility vehicle can include a body to support a rider and a caster wheel assembly on a rear of the body. The caster wheel assembly can include a wheel which can swivel, relative to the body, about a swivel axis. The wheel can rotate, relative to the body, about a rotation axis. The rotation axis can pass through an axial center of the wheel. The caster wheel assembly can include a marker which can swivel with the wheel and mark the riding surface.

In some aspects, the marker includes a stick of chalk.

In some aspects, the marker includes a first mark element on a first axial side of the wheel and a second mark element on a second axial side of the wheel.

In some aspects, the marker can rotate relative to the body and the wheel.

In some aspects, a caster wheel assembly is disclosed herein. The caster wheel assembly can include: a mount; a fork including a first ear and a second ear; a bearing between the mount and the fork such that the fork can swivel relative to the mount; a wheel, and/or a marker assembly. The marker assembly can include a first support, a second support, a body, and/or a dispenser. The dispenser can receive a front portion of a marker and/or enable a rear portion of the marker to protrude from the dispenser. The caster wheel assembly can include an axle that passes through the first and second ears of the fork, the wheel, and the first and second supports of the marker assembly. The marker assembly can rotate, about the axle and relative to the wheel, between a stowed position and a deployed position.

In some aspects, a first end and a second end of the axle protrude out of the respective first and second supports of the marker assembly.

In some aspects, the first ear and the first support are on a first axial side of the wheel and the second ear and the second support are on a second axial side of the wheel.

In some aspects, the caster wheel assembly can further include a latch configured to releasably retain the marker assembly in the stowed position.

In some aspects, the latch includes a resilient arm positioned above the wheel.

In some aspects, the caster wheel assembly can further include a spring configured to bias the marker assembly toward the deployed position.

In some aspects, the marker assembly further includes a spring configured to bias the marker out of the dispenser.

In some aspects, the marker assembly further includes a second dispenser, the dispenser on a first axial side of the wheel and the second dispenser on a second axial side of the wheel.

In some aspects, a combination including the caster wheel assembly and the marker is disclosed herein.

In some aspects, a scooter including a handlebar assembly, a front wheel steerable by the handlebar assembly, a deck configured to support a user, a support connecting a front of the deck to the handlebar assembly, the caster wheel assembly on a rear of the deck is disclosed herein.

In some aspects, a drifting cart including a body, a seat connected to the body, a front having a powered steerable wheel, and a rear having a plurality of the caster wheel assemblies is disclosed herein.

Neither the preceding Summary nor the following Detailed Description and associated drawings purport to limit or define the scope of protection. The scope of protection is defined by the claims.

### BRIEF DESCRIPTION OF THE DRAWINGS

The foregoing and other features of the present disclosure will become more apparent from the following description and appended claims, taken in conjunction with the accompanying drawings. Understanding that these drawings depict only certain embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise.

FIG. 1 illustrates a schematic diagram of a personal transportation vehicle, such as a go cart, including two caster wheel assemblies and two drawing devices.

FIG. 2 illustrates a schematic diagram of a personal transportation vehicle, such as a scooter, including a wheel assembly and a drawing device.

FIG. 3 illustrates a rear perspective view of a personal transportation vehicle including two drawing devices in a stowed position.

FIG. 4 illustrates a rear perspective view of the vehicle of FIG. 3 with the drawing devices in a deployed position.

FIG. 5 illustrates a rear perspective view of a wheel assembly of FIG. 3 with the drawing device in the stowed position.

FIG. 6 illustrates a top view of the wheel assembly of FIG. 5.

FIG. 7 illustrates a bottom view of the wheel assembly of FIG. 5.

FIG. 8 illustrates a rear view of the wheel assembly of FIG. 5.

FIG. 9 illustrates a front view of the wheel assembly of FIG. 5.

FIG. 10 illustrates a right side view of the wheel assembly of FIG. 5 (in certain embodiments the left side view is a mirror image).

FIG. 11 illustrates a side view of the wheel assembly of FIG. 5 with the drawing device in the deployed position.

FIG. 12 illustrates a side, cross-sectional view of the wheel assembly of FIG. 5.

FIG. 13 illustrates a rear perspective view of a wheel assembly with another example drawing device.

FIG. 14 illustrates a rear view of the wheel assembly of FIG. 13.

FIG. 15 illustrates a side, cross-sectional view of the wheel assembly of FIG. 13.

FIG. 16 illustrates a rear perspective view of a rearward portion of a personal transportation vehicle (such as the vehicle of FIG. 3) including another example of a drawing device.

FIG. 17 illustrates a side view of a personal transportation (such as the vehicle of FIG. 3) including another example of a drawing device.

FIG. 18 illustrates a rear perspective view of a rearward portion of a personal transportation vehicle (such as the vehicle of FIG. 3) including another example of a drawing device.

FIG. 19 illustrates a side perspective view of a forward portion of a personal transportation vehicle (such as the vehicle of FIG. 3) including another example of a drawing device.

FIG. 20 illustrates a rear perspective view of a rearward portion of a personal transportation vehicle (such as the vehicle of FIG. 3) including another example of a drawing device.

FIG. 21 illustrates a rear perspective view of another example of a drawing device that can be coupled to a wheel of a personal transportation vehicle.

FIG. 22 illustrates a side view of a wheel assembly including another example of a drawing device.

### DETAILED DESCRIPTION OF CERTAIN EMBODIMENTS

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages without necessarily achieving other aspects or advantages.

This specification provides textual descriptions and illustrations of many devices, components, assemblies, and subassemblies. Any structure, material, function, method, or step that is described and/or illustrated in one example can be used by itself or with or instead of any structure, material, function, method, or step that is described and/or illustrated in another example or used in this field. The text and drawings merely provide examples and should not be interpreted as limiting or exclusive. No feature disclosed herein is considered critical or indispensable. The relative sizes and proportions of the components illustrated in the drawings form part of the supporting disclosure of this specification, but should not be considered to limit any claim unless recited in such claim.

Various embodiments of a drawing device for use with a personal transportation device are disclosed herein. The present disclosure describes certain embodiments of the drawing device in use with a scooter and/or go-kart. However, it will be understood that the subject matter of the present disclosure can be used in many other contexts as well (for example, carts, push karts, soapbox cars, skateboards, caster boards, hoverboards, bicycles, tricycles, and/or other personal transportation devices) and is not limited to the embodiments illustrated in the drawings. The present technology can be implemented in powered or manually operated vehicles.

### A. Overview

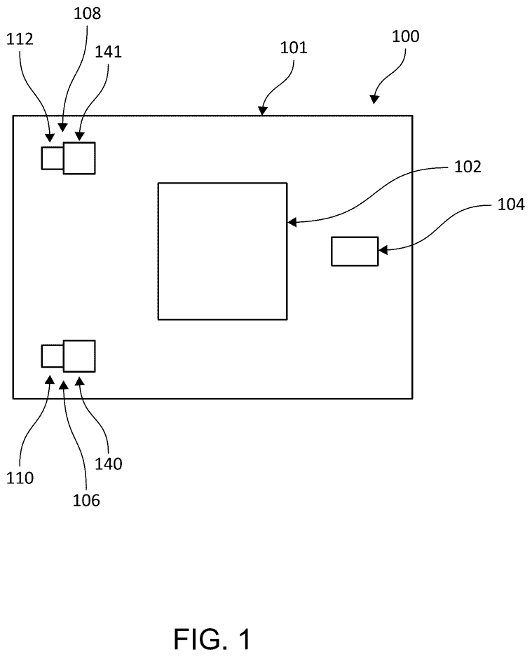

FIG. 1 illustrates a schematic diagram of a vehicle 100. The vehicle 100 can include, but is not limited to, personal mobility devices such as carts, go-karts, push karts, drift karts, soapbox cars, tricycles, or otherwise. The vehicle 100 can include any of the features and/or functionalities described with respect to any of the other vehicles described herein, for example, the vehicles 200, 300.

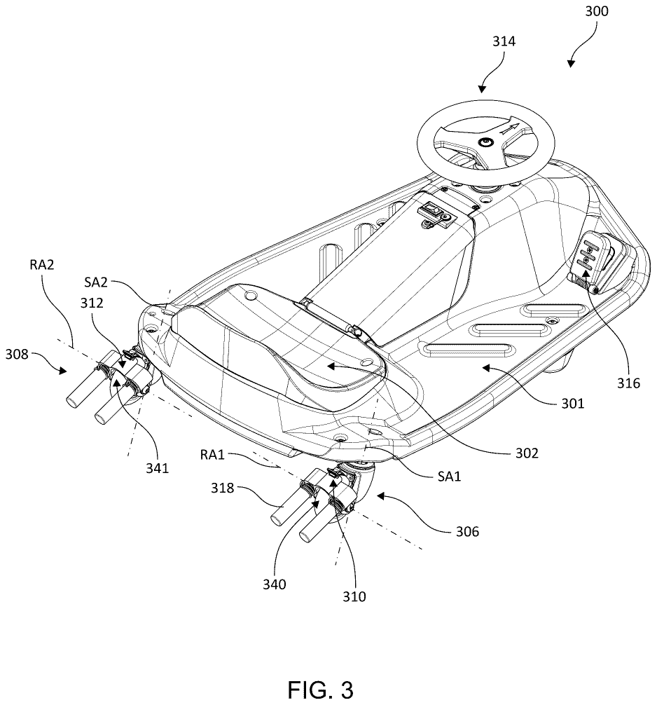

The vehicle 100 includes a body 101, which can position and/or couple to various components to the vehicle 100. The body 101 can include a frame, such as a tubular metal or plastic frame. In some embodiments, the body 101 includes a base, such as a molded plastic or metal floor (see FIG. 3).

The vehicle 100 includes a seat 102 which can be positioned on and/or partially within the body 101. The seat 102 can support a user (e.g., rider) of the vehicle 100. For example, a user can sit upon the seat 102 when utilizing the vehicle 100. The seat can be on a rear of the body 101, which can place the weight of a rider in a position to facilitate drifting of the vehicle, as further discussed below. Certain implementations do not have a seat 102.

The vehicle 100 includes one or more wheels 104 (e.g., steerable wheels). The one or more wheels 104 can be a front wheel or otherwise positioned on a front of the vehicle 100. The one or more wheels 104 can be controlled (e.g., steered, turned) by a user to steer the vehicle 100, for example, by operating a steering unit (e.g., steering wheel, handle, etc.) as further described with respect to FIGS. 3 & 4 herein. The one or more wheels 104 can be driven (e.g., powered, rotated) by a motor (not shown) to drive (e.g., move) the vehicle 100 across the riding surface. In some implementations, the one or more wheels 104 (e.g., steerable wheels) are not driven by a motor. For example, the vehicle 100 can be unpowered. A user can move the vehicle 100 through gravity (e.g., via moving downhill) and/or through human action (e.g., pushing off the riding surface, pedaling, etc.). In some implementations, the one or more wheels 104 do not include a drawing device (discussed below), while in certain variants the one or more of the wheels 104 do include a drawing device.

As shown, the vehicle 100 can include a first wheel assembly 106 and/or a second wheel assembly 108, which can be coupled to and/or positioned by the body 101. The first wheel assembly 106 can be a first caster wheel assembly and/or the second wheel assembly 108 can be a second caster wheel assembly. The first and second wheel assemblies 106, 108 can be first and second rear wheels or are otherwise positioned on a rear portion of the body 101.

The first wheel assembly 106 can include a first drawing device 110 (e.g., drawing assembly, marking assembly, surface marking assembly, chalk dispenser) which can be coupled (e.g., directly or indirectly) to a first wheel 140 (e.g., first rear wheel, first caster wheel). The second wheel assembly 108 can include a second drawing device 112 (e.g., drawing assembly, marking assembly, surface marking assembly, chalk dispenser) which can be coupled (e.g., directly or indirectly) to a second wheel 141 (e.g., second rear wheel, second caster wheel). As shown, the vehicle 100 can include the first and second wheel assemblies 106, 108. In certain variants, the vehicle 100 includes the first wheel assembly 106 or the second wheel assembly 108.

In some implementations, the first and/or second drawing devices 110, 112 can include (e.g., receive and/or position) a marker (e.g., mark element, chalk stick, pencil, pen, brush, crayon, etc.) which can create markings on a surface as the vehicle 100 moves across the surface. In some implementations, the first and/or second drawing devices 110, 112 can be shaped and/or sized to receive (e.g., hold) one or more sticks of chalk. In some implementations, the first and/or second wheel assemblies 106, 108 (e.g., the wheels 140, 141 and/or the drawing devices 110, 112) can swivel (e.g. rotate, pivot) relative to the vehicle 100, for example, as the vehicle 100 turns and/or drifts, such that the drawing devices 110, 112 create erratic, curved, and/or undulating markings on the riding surface as the vehicle 100 moves across the riding surface and the wheels 140, 141 rotate. For example, the first and/or second wheel assemblies 106, 108 can include caster wheels 140, 141 which can swivel relative to the vehicle 100. This may allow a user to create more visually interesting and/or unique markings on the riding surface while riding the vehicle 100. The caster wheels 140, 141 are configured to swivel and rotate.

In some implementations, the drawing device(s) 110, 112 can be movable between a deployed position and a stowed position. In the deployed position, the marker (e.g., chalk stick) can contact the riding surface to provide marking functionality on the riding surface (e.g., as the vehicle 100 moves across the riding surface). In the stowed position, the marker can be spaced from the riding surface to prevent or inhibit marking the riding surface. In some implementations, the drawing device(s) 110, 112 can be rotated (e.g., pivoted) between the deployed and stowed position, for example, about an axis that is generally parallel to and/or generally collinear with an axis of rotation of the respective wheel 140, 141.

The vehicle 100 can include any number of wheel assemblies 106, 108 and/or drawing devices 110, 112, for example, one, two, three, four, five, six, or more than six wheel assemblies 106, 108 and/or drawing devices 110, 112. In some implementations, the number of wheel assemblies 106, 108 can correspond to the number of drawing device 110, 112. For example, each wheel assembly 106, 108 can include a separate drawing device 110, 112. In some implementations, one or more of the wheel assemblies 106, 108 can include more than one drawing device 110, 112 or no drawing device 110, 112.

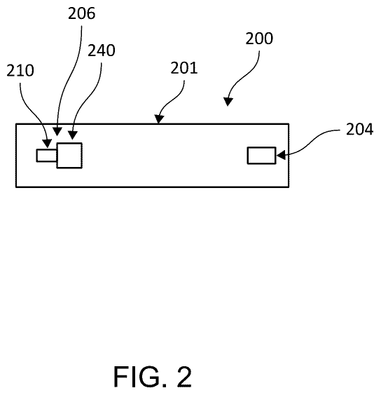

FIG. 2 illustrates a schematic diagram of a vehicle 200 including a single wheel assembly 206 (e.g., caster wheel assembly). The vehicle 200 can include, but is not limited to, personal mobility devices such as scooters, bikes, caster boards, swivel boards, hoverboards, bicycles, or otherwise. The vehicle 200 can include any of the features and/or functionalities described with respect to any of the other vehicles described herein, for example, the vehicles 100, 300.

The vehicle 200 can include a body 201 which can position and/or couple to various components to the vehicle 200. The body 201 can include a deck, which can be configured to support a user. In some implementations, the vehicle 200 does not include a seat and/or is configured such that a user can stand (e.g., place their feet on) the body 201.

The vehicle 200 can include one or more wheels 204 (e.g., front wheels, steerable wheels) which can be positioned on a front of the vehicle 200. The one or more wheels 204 can be controlled (e.g., steered, turned) by a user to steer the vehicle 200, for example, by operating a steering unit (e.g., steering wheel, handlebar, etc.) as further described with respect to FIGS. 3 & 4 herein. The one or more wheels 204 can be driven (e.g., powered, rotated) by a motor (not shown) to drive (e.g., move) the vehicle 200 across a surface. In some implementations, the one or more wheels 204 (e.g., steerable wheels) are not driven by a motor. For example, the vehicle 200 can be unpowered. A user can move the vehicle 200 through gravity (e.g., via moving downhill) and/or through human action (e.g., pushing off the riding surface, pedaling, etc.).

The vehicle 200 includes a wheel assembly 206 coupled to the body 201, such as on a rear end. The wheel assembly 206 can include a caster wheel. The wheel assembly 206 can include a drawing device 210 (e.g., drawing assembly, marking assembly, surface marking assembly) which can be coupled (e.g., directly or indirectly) to a wheel 240 (e.g., rear wheel, caster wheel) of the vehicle 200.

### B. Example Vehicle

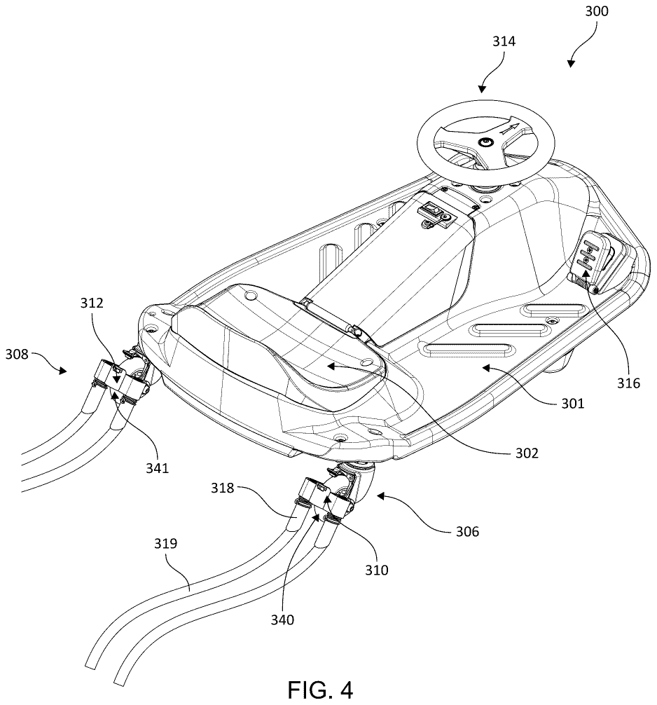

FIG. 3 illustrates a rear perspective view of a vehicle 300 including drawing devices 310, 312 in a stowed position. FIG. 4 illustrates a rear perspective view of the vehicle 300 with the drawing devices 310, 312 in a deployed position. The illustrated vehicle 300 is a drifting cart, due to particular utility in that context. However, the embodiments and inventions disclosed herein can also be applied to other types of personal mobility devices, such as carts, go-karts, push karts, soapbox cars, skateboards, caster boards, scooters, bikes, tricycles, hoverboards, swivel boards, or otherwise.

The vehicle 300 can include any of the features and/or functionalities described with respect to any of the other vehicles described herein, for example, the vehicles 100, 200. The vehicle 300 (and any of the other vehicles described herein) can include any of the features and/or functionalities described in U.S. Pat. No. 9,102,375, issued Aug. 11, 2015, which is hereby incorporated by reference in its entirety. Any of the wheel assemblies and/or drawings devices described herein can be utilized in any of the vehicles 100, 200, and/or 300.

The vehicle 300 can include a body 301 which can position and/or couple to various components to the vehicle 300. For example, a first wheel assembly 306 and/or a second wheel assembly 308 can be coupled to and/or positioned by the body 301. The body 301 can include a frame, such as a tubular metal or plastic frame. As shown in FIG. 3, the body 301 can include a base, such as a molded plastic or metal floor. The frame can extend around some or all of a periphery of the base.

The vehicle 300 can include a seat 302 which can be positioned on and/or partially within the body 301. The seat 302 can be positioned proximate a center and/or a rear portion of the body 301. The seat 302 can support a user (e.g., rider) of the vehicle 300. For example, a user can sit upon the seat 302 when utilizing the vehicle 300. The seat 302 can be integrated with at least a portion of the body 301. For example, the seat 302 and the base of the body 301 can be unitarily formed (e.g., injection molded together).

As shown in FIGS. 3 & 4, the vehicle 300 can include the first wheel assembly 306 (e.g., first caster wheel assembly) and the second wheel assembly 308 (e.g., first caster wheel assembly). In some implementations, the vehicle 300 includes only one of the first and second wheel assemblies 306, 308. The first wheel assembly 306 can include a first drawing device 310 (e.g., drawing assembly, marking assembly, surface marking assembly, chalk dispenser) which can be coupled (e.g., directly or indirectly) to a first wheel 340 (e.g., first rear wheel, first caster wheel). The second wheel assembly 308 can include a second drawing device 312 (e.g., drawing assembly, marking assembly, surface marking assembly) which can be coupled (e.g., directly or indirectly) to a second wheel 341 (e.g., second rear wheel, second caster wheel). The first and/or second wheel assemblies 306, 308 can include any of the features and/or functionalities described with respect to any of the other wheel assemblies described herein, for example, wheel assemblies 106, 108, 206. The first and second wheel assemblies 306, 308 are configured to swivel around respective axes of rotation SA1, SA2 and/or have wheels 340, 341 configured to rotate around respective axes of rotation RA1, RA2.

As mentioned above, the wheel assemblies 306, 308 can be caster wheel assemblies. Caster wheel assemblies can beneficially swivel in various directions (e.g., are not fixed in orientation) while simultaneously rotating over a riding surface, such as pavement, asphalt, concrete, or other ground. Unlike vehicles having marking features associated with a wheel that is fixed in direction relative to the body of the vehicle (such as certain bicycle or scooter rear wheels), a caster wheel with the drawing device 310, 312 can provide enhanced marking functionality, such as by allowing marking paths that would not be possible for wheels fixed in direction (e.g., curving, undulating, and/or erratic marking paths), can permit marking to occur when the vehicle is travelling sideways (e.g., generally perpendicular to the longitudinal axis of the vehicle), enabling marking when the vehicle is spinning in place, and/or providing other benefits.

The vehicle 300 can include any number of wheel assemblies 306, 308 and/or drawing devices 310, 312, for example, one, two, three, four, five, six, or more than six wheel assemblies 306, 308 and/or drawing devices 310, 312. In some implementations, the number of wheel assemblies 306, 308 can correspond to the number of drawing device 310, 312. For example, each wheel assembly 306, 308 can include a separate drawing device 310, 312. In some implementations, one or more of the wheel assemblies 306, 308 can include more than one drawing device 310, 312 or no drawing device 310, 312.

The first and/or second drawing devices 310, 312 can include (e.g., hold, retain, position) one or more markers 318 (e.g., mark elements, chalk sticks, pencils, pens, brushes, crayons, etc.) which can create markings 319 on a surface as the vehicle 300 moves across the surface. The first and/or second drawing devices 310, 312 can position one, two, three, four or more markers 318. For example, as shown in FIGS. 3 & 4, the first and second drawing devices 310, 312 can position two markers 318 on opposite axial sides of the respective wheels 340, 341.

In some implementations, the first and/or second drawing devices 310, 312 can include one or more chalk dispensers. For example, the first and/or second drawing devices 310, 312 can be shaped and/or sized to receive (e.g., hold) one or more sticks of chalk.

In some implementations, the markers 318 can include one or more sparking materials that generate sparks when moved along the riding surface, for example, when the riding path includes materials such as concrete, asphalt, stone, brick, etc. Sparking materials can include but are not limited to metals such as steel, iron, titanium, and/or magnesium; minerals such as flint; and/or alloys such as ferrocerium.

The first and/or second wheel assemblies 306, 308 (e.g., the wheels 340, 341 and/or the drawing devices 310, 312) can swivel (e.g. rotate, pivot) relative to the vehicle 300, for example, as the vehicle 300 turns and/or drifts. This may allow the drawing devices 310, 312 (e.g., the markers 318 thereof) to create erratic, curved, and/or undulating markings 319 on the riding surface as the vehicle 300 moves across the riding surface and the wheels 340, 341 rotate. In some implementations, the wheel assemblies 306, 308 can be capable of swiveling 360°.

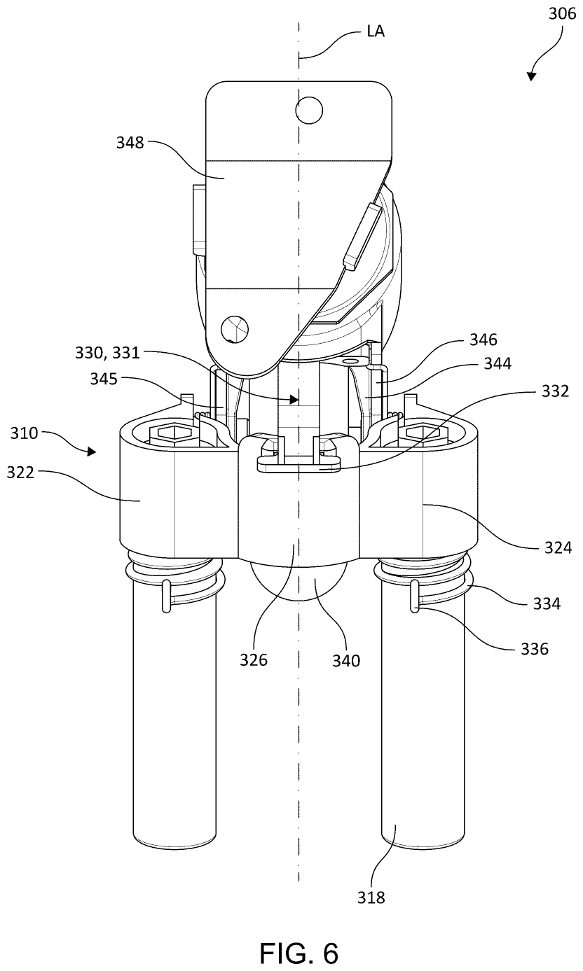

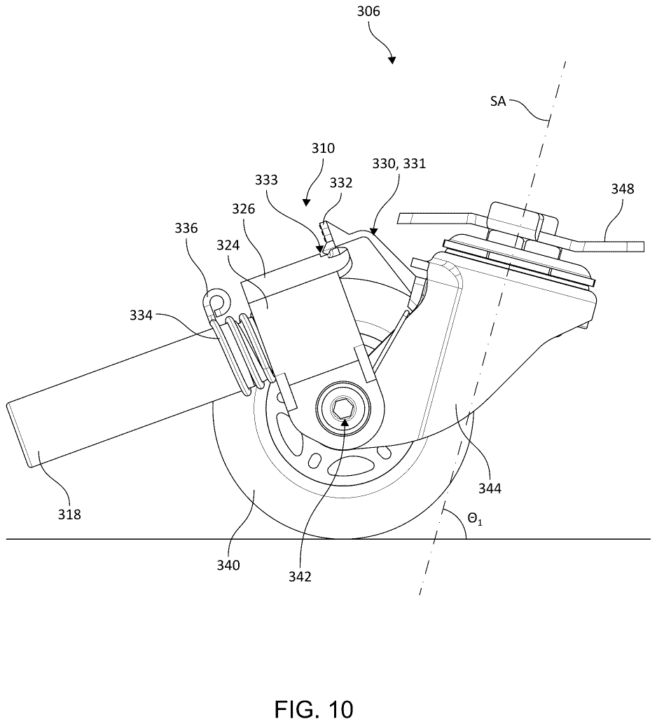

In some implementations, the first and/or second wheel assemblies 306, 308 can be caster wheel assemblies, which may enable the wheel assemblies 306, 308 to swivel relative to the vehicle 100. As mentioned above, the first and/or second wheel assemblies 306, 308 can swivel (e.g., pivot, rotate) about a respective swivel axis SA (see, for example, FIG. 10). The swivel axis can be partially or substantially perpendicular or angled relative to the riding surface, a longitudinal axis of the vehicle 300, and/or a longitudinal axis LA (see, for example, FIG. 6) as further described herein. In certain implementations, the wheels 340, 341 are configured to rotate and/or swivel substantially freely. Certain variants have a spring or other biasing member that biases the wheel assemblies 306, 308 to a “neutral” position (e.g., a position when the vehicle 300 is traveling in a straight line and/or the position of the wheels 340, 341 shown in FIG. 3).

In some implementations, the first and/or second wheel assemblies 306, 308 can couple (e.g., rotatably) to an underside of the body 301. The first and/or second wheel assemblies 306, 308 can be positioned partially or substantially underneath the vehicle 300 (e.g., the body 301) and can assist in supporting the vehicle 300. In some implementations, the first and/or second wheel assemblies 306, 308 can be positioned on opposite lateral sides of the vehicle 300 (e.g., the body 301) which may increase the stability of the vehicle 300 and/or allow a user to generate markings over a greater surface area on the riding surface.

The first and/or second wheel assemblies 306, 308 can be positioned at or proximate a rear end of the vehicle 300 (e.g., the body 301). When the vehicle 300 turns (e.g., drifts) while moving (e.g., driving) in a forward direction, the rear end of the vehicle 300 may move (e.g., laterally) more than a front end of the vehicle 300. Thus, positioning the first and/or second wheel assemblies 306, 308 proximate the rear end of the vehicle 300 may allow the drawing device(s) 310, 312 (e.g., markers 318) to generate larger, more erratic, and/or less linear markings on the riding surface as the first and/or second wheel assemblies 306, 308 move with the rear end of the vehicle 300. The drawing device(s) 310, 312 can mark (e.g., trace) the path of the vehicle 300 (e.g., the rear end of the vehicle 300) as the user drifts the vehicle 300 which may allow a user to visualize the extent and/or shape of the drift.

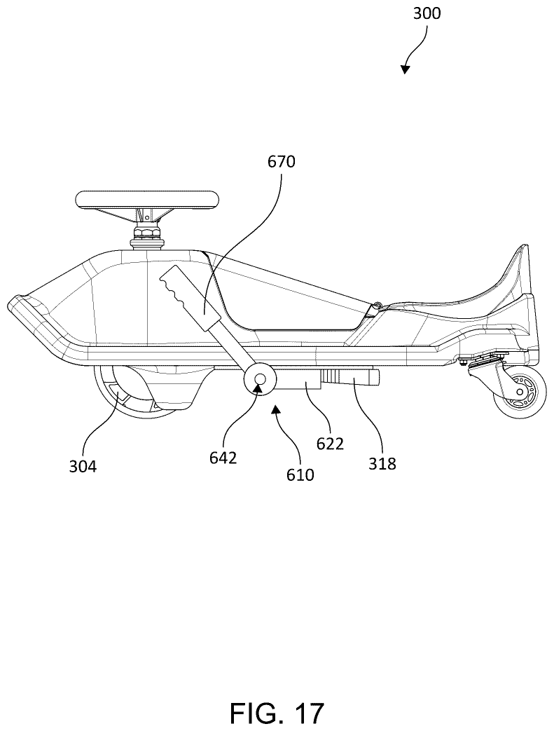

The vehicle 300 can include one or more wheels 304 (e.g., front wheels, steerable wheels) for example, as shown in FIG. 17, which can include any of the features or functionalities described with respect to any of the wheels described herein, for example, the one or more wheels 104, 204. The one or more wheels can be positioned proximate a front of the vehicle 300. The one or more wheels 304 can be controlled (e.g., steered, turned) by a user to steer the vehicle 300, for example, by operating a steering unit 314 (e.g., wheel).

The one or more wheels can be driven (e.g., powered, rotated) by a motor (not shown) to drive (e.g., move) the vehicle 300 across the riding surface. In some implementations, the vehicle 300 can include an actuator 316 (e.g., throttle, pedal, accelerator, brake, etc.) which can be actuated (e.g., by a user's foot) to accelerate and/or decelerate the vehicle 300. For example, depressing the actuator 316 can cause the motor to increase the rotational speed of the one or more wheels (e.g., steerable wheels) to accelerate the vehicle 300. In some implementations, depressing the actuator 316 can cause a brake (not shown) to be actuated to decrease the rotational speed of the one or more wheels (e.g., steerable wheels) to decelerate the vehicle 300. In some implementations, the one or more wheels (e.g., steerable wheels) do not include a drawing device while, in other implementations, one or more of the wheel(s) can include a drawing device. In some implementations, the one or more wheels (e.g., steerable wheels) are not driven by a motor. For example, the vehicle 300 can be unpowered. A user can move the vehicle 300 through gravity (e.g., via moving downhill) and/or through human action (e.g., pushing off the riding surface, pedaling, etc.).

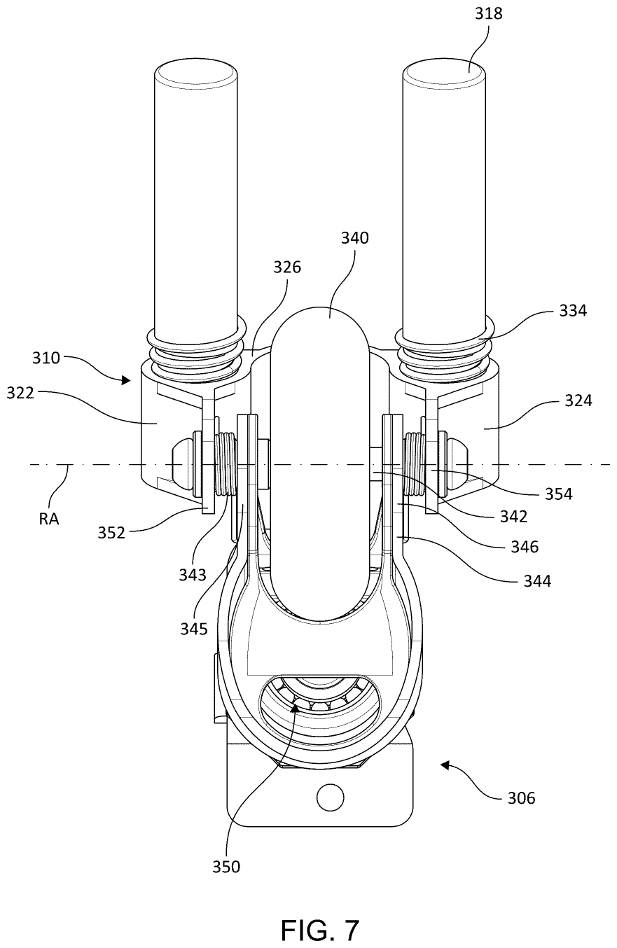

In some implementations, the drawing device(s) 310, 312 can be movable between a deployed position (as shown, for example, in FIG. 3) and a stowed position (as shown, for example, in FIG. 4). In the deployed position, the marker 318 (e.g., a distal, rear, and/or lower end of the marker 318) can contact the riding surface to provide marking functionality on the riding surface (e.g., as the vehicle 300 moves across the riding surface). For example, the marker 318 can generate markings 319 as shown in FIG. 4 when in the deployed position due to contact between the marker 318 and the riding surface. In the stowed position, the marker 318 (e.g., a proximal, forward, and/or upper end of the marker 318) can be spaced from the riding surface to prevent or inhibit marking the riding surface. In some implementations, the drawing device(s) 310, 312 (and thus the markers 318) can be rotated (e.g., pivoted) between the deployed and stowed position, for example, about a rotational axis RA (e.g., rotational axis of the caster wheel) as shown, for example, in FIG. 7. In some implementations, the rotational axis RA can be generally parallel to and/or generally collinear with an axis of rotation of the respective wheel 340, 341 to which each drawing device 310, 312 is coupled. The drawing devices 310, 312 can be independently moveable between the stowed and deployed positions.

The wheel assemblies 306, 308 can be configured to inhibit or prevent interference with the vehicle 300. In some implementations, the wheel assemblies 306, 308 have a clearance, regardless of the rotational position of the wheel assemblies 306, 308, between the wheel assemblies 306, 308 (including the respective drawing devices 310, 312 and markers 318) and the body 301 of the vehicle 300. The wheel assemblies 306, 308 can be configured to not impact (e.g., abut) the body 301. For example, in the examples shown in FIGS. 3 and 4, the wheel assemblies 306, 308 can spin without physically contacting the body 301 that the wheel assemblies 306, 308 are mounted to. In some implementations, the wheel assemblies 306, 308 can be configured to spin 360° and/or to not impact the body 301 in the stowed and deployed positions.

### C. Example Wheel Assembly

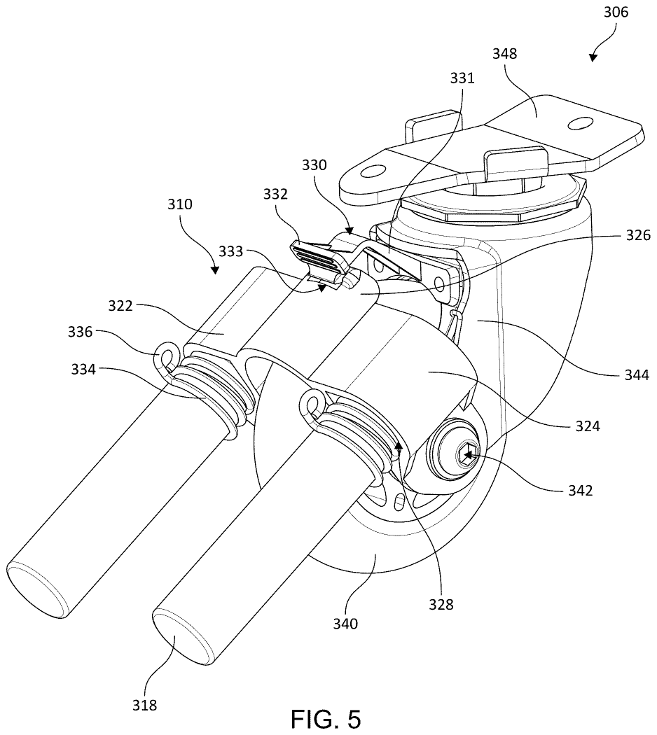

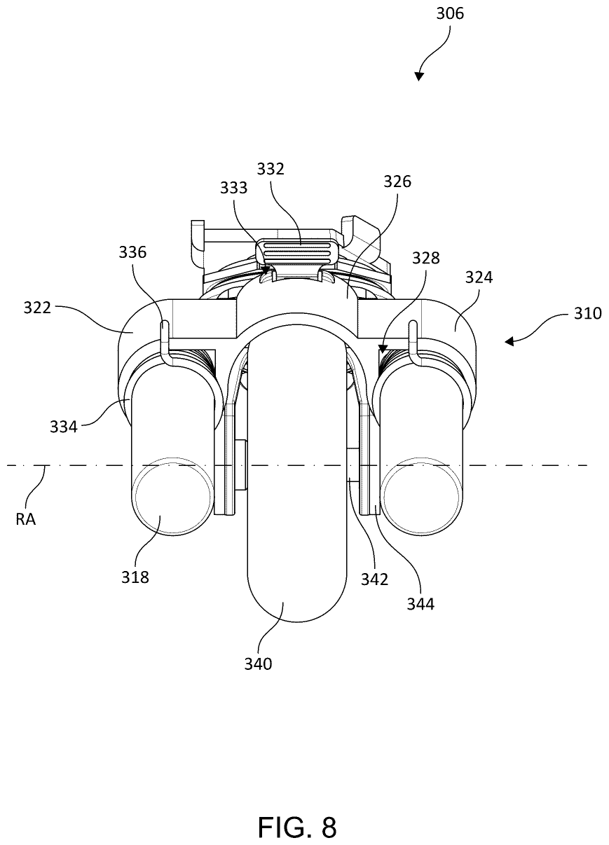

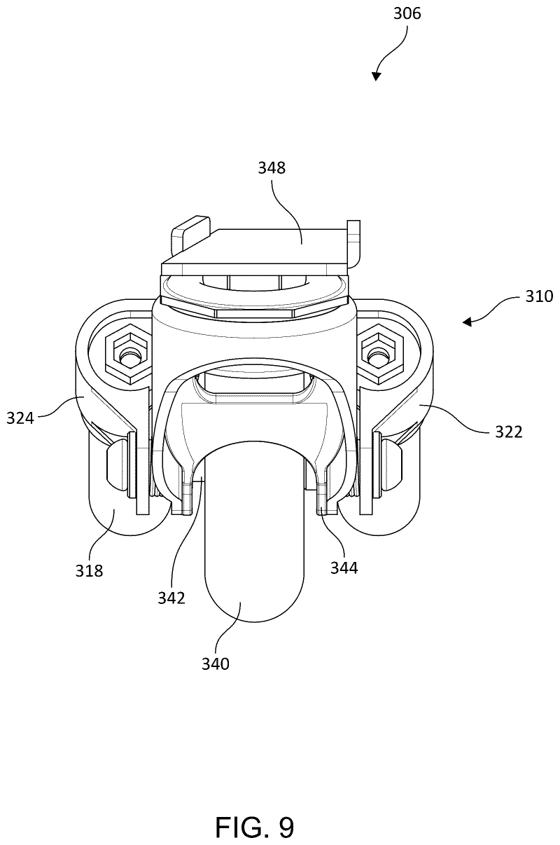

FIGS. 5-12 illustrate various views of the first wheel assembly 306 (e.g., first caster wheel assembly) including the first drawing device 310 (e.g., drawing assembly, marking assembly, surface marking assembly, chalk dispenser). The first wheel assembly 306 can be utilized in any of the vehicles described herein (e.g., vehicles 100, 200, 300) or any other vehicle. The first wheel assembly 306 and/or the second wheel assembly 308 can include any of the features and/or functionalities described with respect to any of the other wheel assemblies described herein, for example, the wheel assemblies 106, 108, 206, 406. In some implementations, the second wheel assembly 308 can be similar or identical to the first wheel assembly 306. In some implementations, the second wheel assembly 308 can be a mirrored version of the first wheel assembly 306 (e.g., across the longitudinal axis of the vehicle 300).

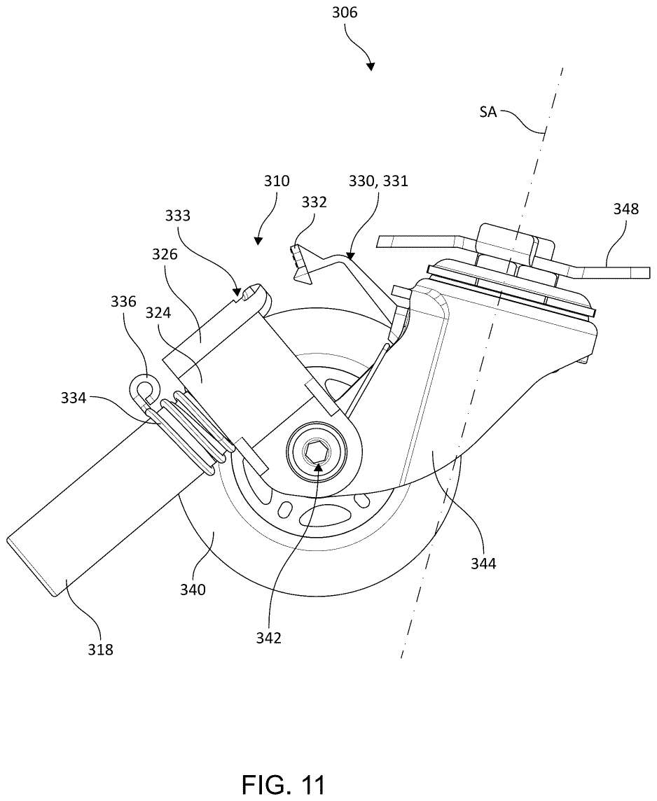

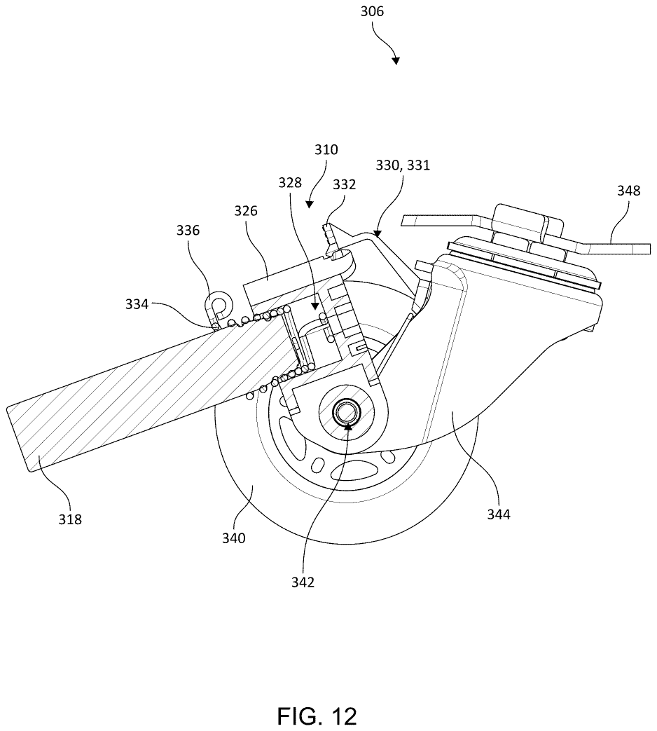

FIG. 5 illustrates a rear perspective view of the wheel assembly 306 with the drawing device 310 in the stowed position. FIGS. 6-10 illustrate a top, bottom, rear, front, and side view, respectively, of the wheel assembly 306 with the drawing device 310 in the stowed position. FIG. 11 illustrates a side view of the wheel assembly 306 with the drawing device 310 in the deployed position. FIG. 12 illustrates a side, cross-sectional view of the wheel assembly 306 with the drawing device 310 in the stowed position.

The wheel assembly 306 can include a mount 348 (e.g., bracket), a support 344 (e.g., a fork, arm, etc.), fastener 342 (e.g., axle, pin), the wheel 340 (e.g., rear wheel, caster wheel), and the drawing device 310 (e.g., drawing assembly, marking assembly, surface marking assembly, chalk dispenser). Certain implementations include a lock 330 (e.g., retention mechanism, latch) and/or a one or more bearings 350 (e.g., ball bearings, roller bearings, sleeve bearings, etc.).

The wheel assembly 306 can couple to the vehicle 300 (e.g., the body 301) via the mount 348. The mount 348 can be positioned at or proximate a first (e.g., top and/or forward) end of the wheel assembly 306 such that the wheel assembly 306 extends away (e.g., downward and/or rearward) from the vehicle 300 (e.g., the body 301). The mount 348 can be angled (e.g., rearward) relative to the riding surface, the longitudinal axis of the vehicle 300, and/or the longitudinal axis LA such that the wheel assembly 306 is angled (e.g., rearward) relative to the riding surface, which may increase the stability of the vehicle 300. The longitudinal axis LA can be the longitudinal axis of the wheel assembly 306 and/or the drawing device 310. The longitudinal axis LA can be generally parallel to the riding surface and/or the longitudinal axis of the vehicle 300. For example, the longitudinal axis LA can be horizontal.

In some implementations, the mount 348 can be fixed to the vehicle 300 such that the mount 348 is inhibited or prevented from swiveling (e.g., pivoting) relative to the vehicle 300. For example, the wheel 340 can be fixedly aligned with the longitudinal axis LA of the vehicle 300. In some implementations, the wheel assembly 306 can removably couple to the vehicle 300 via the mount 348. In some implementations, the wheel assembly 306 and thus the drawing device 310 can be substantially permanently attached to the vehicle 300 (e.g., via the mount 348). For example, the wheel assembly 306 and thus the drawing device 310 can be attached to the vehicle 300 such that removal is inhibited or prevented without the use of a tool such as a wrench or screwdriver.

The wheel assembly 306 (e.g., one or more components of the wheel assembly 306 such as the support 344, drawing device 310, wheel 340, and/or marker 318) can be free to swivel (e.g., pivot, rotate) relative to the mount 348 and the vehicle 300, for example, about the swivel axis SA. For example, the wheel assembly 306 or components thereof (such as the support 344, drawing device 310, wheel 340, and/or marker 318) can swivel as a unit relative to the body 301 of the vehicle 300. In some implementations, the one or more bearings 350 can enable the wheel assembly 306 to swivel (e.g., pivot, rotate) relative to the mount 348 and/or the vehicle 300 (see, for example, FIG. 7). The one or more bearings 350 can be positioned between the mount 348 and the support 344 such that the support 344, and thus the wheel assembly 306, can swivel (e.g., pivot, rotate) relative to the mount 348. In some implementations, the support 344 can couple (e.g., directly or indirectly) to the mount 348 and thus the vehicle 300 via the one or more bearings 350.

In some implementations, the swivel axis SA can extend through a center of the one or more bearings 350. For example, the swivel axis SA can be concentrically aligned with an annular or circular raceway of the one or more bearings 350. In some implementations, the swivel axis SA can be partially or substantially orthogonal to the mount 348. In some implementations, the swivel axis SA can be partially or substantially perpendicular to the riding surface, the longitudinal axis of the vehicle 300, and/or the longitudinal axis LA. For example, the swivel axis SA can be partially or substantially vertical.

In some implementations, the swivel axis SA can be angled rearward such that that wheel assembly 306 extends at least partially rearward, which may increase the stability of the vehicle 300 as the wheel assembly 306 swivels. For example, the swivel axis SA can form an angle θ₁ with the riding surface, the longitudinal axis of the vehicle 300, and/or the longitudinal axis LA. In some implementations, the angle θ₁ can be approximately 70 degrees. For example, the angle θ₁ can be between about 90 degrees and 50 degrees, for example, between about 85 degrees and 55 degrees, between about 80 degrees and 60 degrees, between about 75 degrees and 65 degrees, or any value or range between or bounded by these values or ranges.

The support 344 can couple (e.g., directly or indirectly) to the wheel 340 to couple the wheel 340 to the vehicle 300. For example, the support 344 can include a first ear 345 (e.g., leg) and a second ear 346 (e.g., leg) positioned on opposite axial (e.g., lateral) sides of the wheel 340. The support 344 (e.g., the first and second ears 345, 346) can couple (e.g., rotationally) to the wheel 340 via the fastener 342 (e.g., axle, pin). For example, the fastener 342 can extend through the wheel 340 and the first and second ears 345, 346 of the support 344. The fastener 342 can extend through a center (e.g., axial center) of the wheel 340. The wheel 340 can rotate (e.g., roll along the riding surface) about the fastener 342. In some implementations, the fastener 342 can be partially or substantially horizontal relative to the riding surface, the longitudinal axis of the vehicle 300, and/or the longitudinal axis LA. In some implementations, the wheel 340 can be disposed between and spaced from the ears 345, 346 such that the wheel 340 is prevented or inhibited from contacting the support 344 which may improve the rolling performance of the wheel 340.

The drawing device 310 can include a first receptacle 322 (e.g., dispenser, wing, marking device holder, lateral portion, holding portion), which can be positioned proximate a first axial (e.g., lateral) side of the wheel 340. The drawing device 310 can include a second receptacle 324 (e.g., dispenser, wing, marking device holder, lateral portion, holding portion), which can be positioned proximate a second axial (e.g., lateral) side of the wheel 340 opposite the first receptacle 322. The first and second receptacles 322, 324 can each comprise a hollow chamber and/or are configured to hold a marker 318, such as a chalk stick, as discussed below.

The drawing device 310 can include a bridge 326 (e.g., connector, central portion) connecting the first receptacle 322 to the second receptacle 324 and/or connecting to other portions of the wheel assembly 306 (e.g., fastener 342 and/or support 344). In some implementations, the bridge 326 can be positioned at least partially above the wheel 340, such as when the drawing device 310 is in the stowed position. The bridge 326 can space the receptacles 322, 324 from the wheel 340 on opposite axial sides of the wheel 340. The bridge 326 can be spaced from the wheel 340 to avoid inhibiting rotation of the wheel 340. In some implementations, as illustrated, the bridge 326 can be arcuate (e.g., concave in the direction of the wheel 340) to provide additional clearance for the wheel 340 to rotate. In some implementations, the bridge 326, the first receptacle 322, and/or the second receptacle 324 can form a body of the drawing device 310. In some implementations, the body of the drawing device 310 can also include one or more supports 352, 354 as further described herein.

The first and/or second receptacles 322, 324 can be shaped and/or sized to receive (e.g., hold, retain) a marker 318 (e.g., a first, proximal, and/or front end of the marker 318). For example, the first and/or second receptacles 322, 324 can be partially or substantially cylindrical in shape (e.g., when the marker 318 is partially or substantially cylindrical in shape). The drawing device 310 (e.g., the first and second receptacles 322, 324) can position markers 318 on opposite axial (e.g., lateral) sides of the wheel 340 such that the drawing device 310 can generate markings 319 on both sides of the wheel 340 (e.g., when in the deployed position). For example, the first receptacle 322 can position a first marker 318 on a first axial side of the wheel 340 and the second receptacle 324 can position a second marker 318 on a second, opposite axial side of the wheel 340. This can increase the amount of markings 319 created and/or can inhibit the occurrence of drag on only one axial side of the wheel 340 (which may cause unintentional turning of the wheel 340). In various embodiments, the drawing device 310 is configured to provide substantially equal drag on both axial sides of the wheel 340 and/or to inhibit applying a torque to the wheel 340 that may cause the wheel 340 to swivel.

The first and/or second receptacles 322, 324 can include a channel 328 (e.g., cavity, pocket, slot) shaped and sized to receive at least a portion (e.g., a proximal end, front end) of a marker 318. In some implementations, the channel(s) 328 can be partially or substantially cylindrical in shape. The receptacles 322, 324 (e.g., channel(s) 328) can include an open first (e.g., distal, rear) end to receive a marker 318 and a closed second (e.g., proximal, front). The closed second end can limit the maximum insertion depth of the marker 318. In some implementations, the open end can be positioned proximate a bottom and/or rear end of the receptacles 322, 324 (e.g., channel(s) 328) such that a marker 318 can be inserted into the receptacles 322, 324 (e.g., channel(s) 328) from below and/or behind the drawing device 310. In some implementations, the closed end can be positioned proximate a top and/or front end of the receptacles 322, 324 (e.g., channel(s) 328) such that the marker 318 cannot extend forward beyond the receptacles 322, 324 (e.g., channel(s) 328). This can inhibit or prevent interference (e.g., contact) between the marker 318 and other components of the wheel assembly 306, for example, the support 344.

In some implementations, as shown, the marker(s) 318 (e.g., a distal or rear end of the marker(s) 318) can protrude from the drawing device 310 (e.g., the channel(s) 328 of the respective receptacles 322, 324). The protruding portion of the marker(s) 318 can contact the riding surface without allowing the drawing device 310 to contact the riding surface. In some implementations, the length of the protruding portion is greater than the length of the non-protruding portion and/or the protruding portion is at least majority of the overall length of the marker 318, such as least about: 50%, 60%, 75%, or more. In some implementations, the first (e.g., proximal, front) end of the markers 318 can be fully contained within (e.g., surrounded by) the receptacles 322, 324 (e.g., the channels 328 thereof) such that the first end of the marker 318 is obscured or not visible.

In some implementations, the channel(s) 328 can be oriented (e.g., angled) rearward and/or downward such that the marker(s) 318 are oriented (e.g., angled) rearward and/or downward when received in the channel(s) 328. Angling the marker(s) 318 rearward may decrease the force (e.g., longitudinal force) exerted on the marker(s) 318 when the vehicle 300 moves (e.g., drives) in the forward direction which may decrease the risk of damage to the marker(s) 318. Angling the marker(s) 318 downward may allow the marker(s) 318 to more easily and/or consistently contact the riding surface in order to generate markings on the riding surface. In some implementations, when the marker(s) 318 are received in the channel(s) 328 (e.g., in the stowed and/or deployed position), the front end of the marker(s) 318 is positioned forward of a rear edge of the wheel 340 and/or the rear end of the marker(s) 318 is positioned rearward of the rear edge of the wheel 340.

In some implementations, the first and/or second receptacles 322, 324 can include a flexing element, such as a slit. The slit can extend along a longitudinal axis of the receptacles 322, 324. The slit can extend along a portion of or an entire length of the receptacles 322, 324. The slit may increase the flexibility of the receptacles 322, 324 to allow a user to more easily insert and/or remove markers 318 of different shapes and/or sizes. For example, the slit may allow the receptacles 322, 324 to more easily expand outward (e.g., radially) to accommodate markers 318 that are larger (e.g., have a greater diameter than) the channel(s) 328.

In some implementations, the drawing device 310 can include one or more marker holders (e.g., marker biasing members 334). The marker biasing members 334 can be, for example, springs, torsion springs, coil springs, elastomeric material, etc. In some implementations, the biasing members 334 can be positioned at least partially within the first and/or second receptacles 322, 324. For example, each receptacle 322, 324 can include a biasing member 334 disposed at least partially within the channel 328 of the receptacle 322, 324. The biasing members 334 can be coupled to the respective receptacle 322, 324, for example, to the closed end of the respective channel 328. The biasing members 334 can assist in holding the markers 318 in place while the vehicle 300 moves across the riding surface and the markers 318 contact the riding surface. For example, the markers 318 can be disposed at least partially within and/or couple to the biasing members 334.

In some implementations, the marker holders (e.g., biasing members 334) can grip the markers 318. For example, the biasing members 334 can be cylindrically shaped springs sized to surround the first, front end of the markers 318. The biasing members 334 can flex (e.g., expand, contract) to accommodate markers 318 of different sizes (e.g., widths, diameters). In some implementations, the front end of the markers 318 can fit within a longitudinal opening of the biasing members 334 (e.g., springs). The biasing members 334 can exert an inward biasing force on the markers 318 to grip the markers 318 in order to inhibit the markers 318 from inadvertently decoupling from the drawing device 310.

In some implementations, the biasing members 334 can include an actuator, such as a leg 336 (e.g., spring leg, tang, arm). The actuator can be actuated (e.g., squeezed) by a user to open (e.g., radially expand) the biasing member 334. A user can actuate the leg 336 when they wish to insert or remove a marker 318 from the receptacles 322, 324. For example, a user can exert a force on the leg 336 that exceeds the inward biasing force of the biasing member 334 to expand the biasing member 334 and increase the ease with which a marker 318 can be inserted or removed from the receptacles 322, 324. As shown, a top of the actuator can be positioned above the marker 318 and/or below a top of the wheel 340, and/or the actuator can be located rearward and/or above the wheel's 340 axis or rotation,

In some implementations, the biasing members 334 can bias (e.g., move) the markers 318 toward the riding surface. For example, the biasing members 334 can exert a biasing force along the longitudinal axis of the channels 328 (e.g., in the direction of the second, open end of the channels 328, in the direction of the longitudinal axis of the markers 318) which can be oriented at least partially in the direction of the riding surface. Biasing the markers 318 toward the riding surface can increase the intensity and/or consistency of contact between the markers 318 and the riding surface, thereby increasing the intensity and/or consistency of the markings 319 created on the riding surface. For example, as the vehicle 300 moves along the riding surface, the riding surface can exert an upward force on the markers 318 which may decrease contact between the markers 318 and the riding surface. The biasing force exerted by the biasing members 334 can at least partially counteract the upward force exerted by the riding surface to increase the consistency of contact between the markers 318 and the riding surface.

In some implementations, the drawing device 310 can couple to the wheel assembly 306 (e.g., the wheel 340) via the fastener 342 (e.g., axle, pin). For example, the drawing device 310 can include a first support 352 and a second support 354 positioned on opposite axial (e.g., lateral) sides of the wheel 340. In some implementations, the wheel 340 can be disposed between and spaced from the supports 352, 354 such that the wheel 340 is prevented or inhibited from contacting the supports 352, 354 which may improve the rolling performance of the wheel 340. In some implementations, the drawing device 310 can be spaced from the wheel 340 to avoid inhibiting rotation of the wheel 340. The fastener 342 can extend through the wheel 340 and the first and second supports 352, 354 of the drawing device 310 to couple (e.g., rotationally) the drawing device 310 to the wheel 340. For example, a first and second end of the fastener 342 can protrude out of the respective first and second supports 352, 354 of the drawing device 310. The fastener 342 (e.g., axle, pin) can inhibit or prevent lateral movement of the drawing device 310, for example, via one or more fasteners (e.g., screws, bolts, etc.) positioned at the first and second ends of the fastener 342. In some implementations, the fastener 342 can extend through the first and second ears 345, 346 of the support 344, the wheel 340, and the first and second supports 352, 354 of the drawing device 310 to couple the ears 345, 346, the wheel 340, and the supports 352, 354 together. For example, the fastener 342 can extend, in order, through the first support 352, the first ear 345, the wheel 340, the second ear 346, and the second support 354. The first and second supports 352, 354 can be positioned outside (e.g., outward of) the first and second ears 345, 346. In some implementations, the first and second supports 352, 354 can be positioned inside (e.g., inward of) the first and second ears 345, 346.

As described herein, the drawing device 310 can rotate about the rotational axis RA between the stowed position (see, for example, FIG. 10) and the deployed position (see, for example, FIG. 11). For example, the drawing device 310 can be rotated (e.g., pivoted) upward to the stowed position (e.g., clockwise in the view of FIGS. 10-12) and/or can be rotated (e.g., pivoted) downward to the deployed position (e.g., counterclockwise in the view of FIGS. 10-12). The drawing device 310 can be transitioned between the stowed and deployed positions while coupled to the vehicle 300 (e.g., the body 301 of the vehicle 300). In some implementations, the rotational axis RA can be defined by the fastener 342 such that the drawing device 310 can be rotated between the stowed and deployed positions about the fastener 342 and relative to the wheel 340 (e.g., the rotational axis of the wheel 340). In some implementations, when the drawing device 310 is in the deployed position, the front end of the marker 318 can be positioned forward of the rear edge of the wheel 340, and/or the rear end of the marker 318 can be positioned rearward of the rear edge of the wheel 340. Positioning the rear end of the marker 318 rearward of the rear edge of the wheel 340 may allow the rear end of the marker 318 to generate markings 319 on the riding surface without the wheel 340 contacting and/or smudging the markings 319 (e.g., when the vehicle 300 is moving forward). When the drawing device 310 is in the stowed position, an angle between the longitudinal axis of the marker 318 and horizontal (e.g., the riding surface and/or the longitudinal axis LA) can be approximately 20 degrees, for example, between about 5 degrees and 35 degrees, between about 10 degrees and 30 degrees, between about 15 degrees and 25 degrees, or any value or range within or bounded by any of these values or ranges.

In some implementations, the drawing device 310 can be biased toward the deployed position (e.g., downward) by one or more biasing members 343 (e.g., springs, torsion springs, coil springs, elastomeric material, etc.) as shown, for example, in FIG. 7. The biasing members 343 can be positioned on (e.g., disposed around) the fastener 342 (e.g., axle). In some implementations, the drawing device 310 can include two biasing members 343 positioned proximate opposite ends of the fastener 342. For example, a first biasing member 343 can be positioned between the first ear 345 and the first support 352 and/or a second biasing member 343 can be positioned between the second ear 346 and the second support 354. The biasing members 343 can exert a rotational biasing force on the drawing device 310 (e.g., via the supports 352, 354) to bias the drawing device 310 toward the deployed position (e.g., downward). In some implementations, the drawing device 310 can be additionally or alternatively biased toward the deployed position (e.g., downward) by a gravitational force.

In some implementations, the drawing device 310 can compensate for changes in length of the marker 318 during use. This can facilitate maintaining consistent contact between the marker 318 and the riding surface. For example, the drawing device 310 can automatically rotate about the rotational axis RA (e.g., the fastener 342) when in the deployed position (e.g., when not engaged by the lock 330) depending on the length of the marker 318. For example, when the marker 318 includes a material that decreases in length during use, such as a chalk stick, the drawing device 310 can compensate for the decreasing length of the marker 318 by rotating further toward the riding surface (e.g., due to the force of gravity and/or the biasing force of the biasing members 343) until the marker 318 contacts the riding surface. If a user inserts a longer marker 318 into the drawing device 310, the drawing device 310 can compensate for the increased length by rotating less toward the riding surface (e.g., due to an upward force exerted by the riding surface on the drawing device 310 through contact with the marker 318). Similarly, the drawing device 310 can compensate for uneven riding surfaces by rotating about the rotational axis RA in response to changes in height of the riding surface in order to allow the drawing device 310 to consistently contact the uneven riding surface.

In some implementations, the drawing device 310 can be releasably retained (e.g., locked) in the stowed position via the lock 330 (e.g., retention mechanism, latch). The lock 330 can include at least an arm 331 and/or a release 332 (e.g., tab, button, lever, or otherwise). In some implementations, the lock 330 (e.g., the arm 331 thereof) can be coupled to the support 344. In some implementations, the lock 330 (e.g., the release 332 and/or the arm 331) can be formed of a flexible and/or resilient material to permit rotation and/or bending of the lock 330 (e.g., the arm 331) under force. For example, a user can actuate (e.g., exert a force on) the release 332 to rotate (e.g., pivot) and/or bend the arm 331. In some implementations, a user can exert an upward force on (e.g., lift) the release 332 to rotate and/or bend the lock 330 upward (e.g., away from the drawing device 310), and/or the user can exert a downward force on (e.g., lower) the release 332 to rotate and/or bend the lock 330 downward (e.g., toward the drawing device 310). In some implementations, the lock 330 can be rotated and/or bent about a partially or substantially horizontal axis which may be generally parallel to the rotational axis RA. In some implementations, the lock 330 can be rotatably (e.g., pivotably) coupled to the support 344. As illustrated, the lock can 330 comprise an arm 331 that is cantilevered and/or has a free end.

The lock 330 can releasably engage (e.g., physically interfere with) the drawing device 310 to maintain the drawing device 310 in the stowed position. For example, the lock 330 (e.g., a protrusion thereof) can engage (e.g., be inserted into) a mating component, such as a slot 333 (e.g., recess, opening) of the drawing device 310 to maintain the drawing device 310 in the stowed position. The lock 330 can prevent or inhibit the drawing device 310 from transitioning to the deployed position (e.g., rotating downward). In some implementations, the slot 333 can be positioned on and/or in the bridge 326 of the drawing device 310.

The lock 330 (e.g., the release 332 thereof) can be actuated by a user to disengage the lock 330 from the drawing device 310, thereby allowing the drawing device 310 to transition toward the deployed position (e.g., due to the biasing force of gravity and/or the one or more biasing members 343). For example, when a user wishes to create markings 319 on a riding surface, the user can exert an upward force on the release 332 to rotate and/or bend the lock 330 (e.g., the arm 331) upward (e.g., away from the drawing device 310) until the lock 330 no longer engages the drawing device 310 (e.g., is removed from the slot 333). In various implementations, after removal of the engagement between the lock 330 and mating component, the drawing device 310 automatically moves (e.g., snaps) toward the deployed position, for example, because of the biasing member(s) 343. In some implementations, a user can alternatively or additionally exert a downward force on the drawing device 310 to disengage the lock 330 from the drawing device 310 and/or to move the drawing device 310 to the deployed position.

When a user no longer wishes to create markings 319 on the riding surface, the user can exert an upward force on the drawing device 310 (e.g., lift the drawing device 310) until the lock 330 engages the drawing device 310 (e.g., is received by the slot 333), thereby transitioning the drawing device 310 to the stowed position. In some implementations, a user can alternatively or additionally exert a downward force on the lock 330 (e.g., the release 332) to rotate and/or bend the lock 330 (e.g., the arm 331) downward (e.g., toward the drawing device 310) until the lock 330 engages drawing device 310. The user can thus secure the drawing device 310 in the stowed position, which can avoid making markings in areas in which markings are undesired and/or can reduce friction from the marker 318 on the riding surface. The top of the lock 330 and/or the portion of the lock 330 that is contacted by a user can be positioned above the wheel 340 and/or below the body 301 of the vehicle 300. For example, as shown in FIGS. 10-12, a vertical line that passes through the wheel's 340 axis of rotation passes through the lock 330.

In some implementations, the lock 330 (e.g., the arm 331) can be biased toward a default position (e.g., by one or more biasing elements and/or the flexible material of the lock 330) for example, as shown in FIG. 10. In some implementations, the default position of the lock 330 can correspond to the stowed position of the drawing device 310. In some implementations, the release 332 can be positioned underneath the vehicle 300 (e.g., the body 301 of the vehicle 300).

Certain implementations have independently controllable markers 318. For example, in certain variants the receptacles 322, 324 can move independently of the other and/or are not rigidly connected by the bridge 326. The receptacles 322, 324 can have each have an associated lock 330, such that each receptacle 322, 324 can be locked or unlocked (e.g., deployed or stowed) independent of the other receptacle 322, 324. This can allow a user to vary and choose the marking pattern. For example, in an embodiment with a green marker in one of the receptacles 322, 324 and white marker in another one of the receptacles 322, 324, the user can select between marking green only, white only, green and white, or no marking.

In some implementations, the wheel assembly 306 (e.g., the drawing device 310 and/or the support 344) does not exert an axially inward force on the wheel 340 or exerts a low axially inward force on the wheel 340. For example, in some implementations, the wheel assembly 306 (e.g., the drawing device 310 and/or the support 344) applies less than about 0.5 lbs., about 1 lb., or about 2 lbs. of axially inward force on the wheel 340. Reducing or avoiding an axially inward force on the wheel 340 can reduce friction, decrease wear, reduce heat generation and/or noise, and/or can increase efficiency.

### D. Additional Example Wheel Assembly

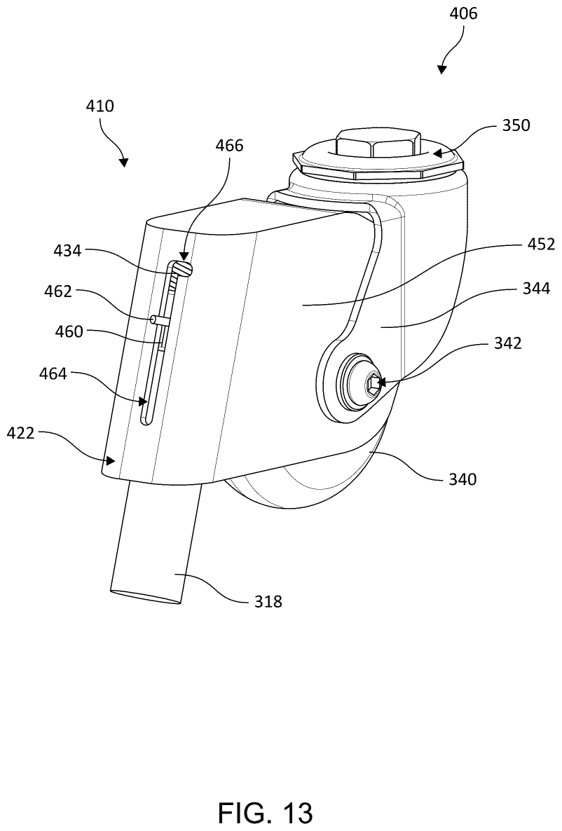

FIGS. 13-15 illustrate various views of a wheel assembly 406 (e.g., caster wheel assembly) which can include any of the features and/or functionalities described with respect to any of the other wheel assemblies described herein, for example, the wheel assemblies 106, 108, 206, 306, 308 (e.g., as indicated by similar or identical components having the same reference numbers). For example, the wheel assembly 406 can include a drawing device 410 (e.g., drawing assembly, marking assembly, surface marking assembly, chalk dispenser) to selectively generate markings on a riding surface. The drawing device 410 can include any of the features and/or functionalities described with respect to any of the other drawing devices described herein, for example, the drawing devices 110, 112, 210, 310, 312. The wheel assembly 406 and/or the drawing device 410 can be utilized in any of the vehicles described herein (e.g., vehicles 100, 200, 300) or any other vehicle.

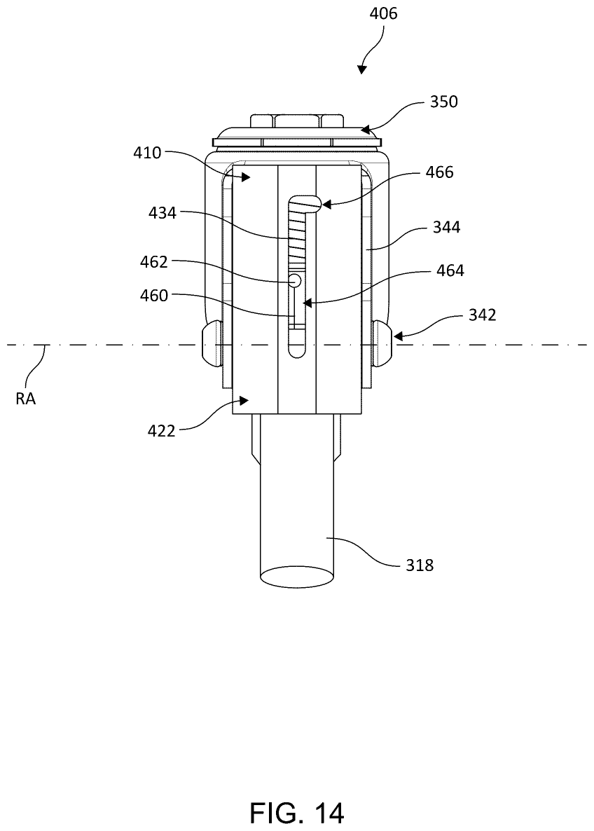

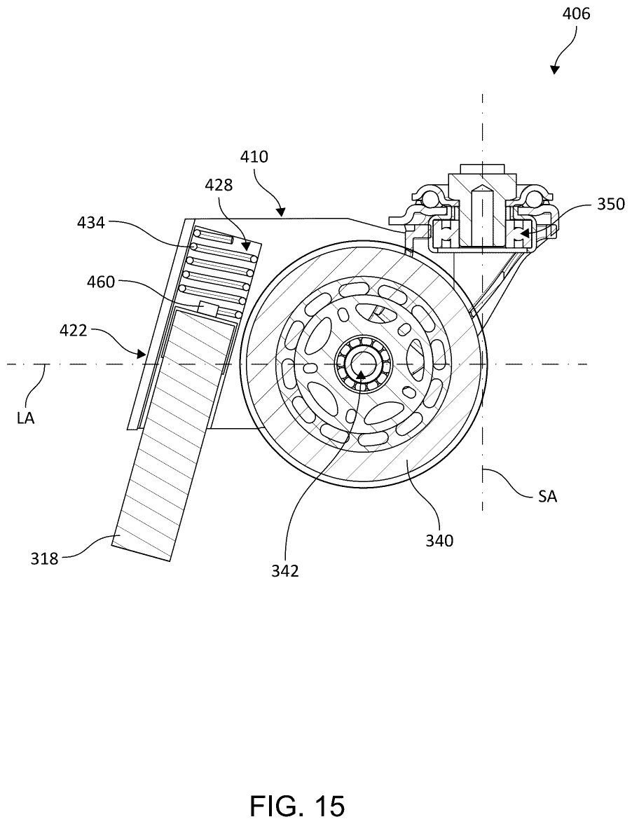

FIG. 13 illustrates a rear, perspective view of the wheel assembly 406 with the drawing device 410 in a deployed position. FIG. 14 illustrates a rear view of the wheel assembly 406 with the drawing device 410 in the deployed position. FIG. 15 illustrates a side, cross-sectional view of the wheel assembly 406 with the drawing device 410 in the deployed position. As illustrated, in several embodiments, the drawing device 410 is used with a caster wheel.

The drawing device 410 can couple to the wheel assembly 406 (e.g., the wheel 340) via the fastener 342 (e.g., axle, pin). For example, the drawing device 410 can include supports (e.g., two supports) 452 positioned on opposite axial (e.g., lateral) sides of the wheel 340. In some implementations, the wheel 340 can be disposed between and spaced from the supports 452 such that the wheel 340 is prevented or inhibited from contacting the supports 452. In some implementations, the drawing device 410 can be spaced from the wheel 340 to avoid inhibiting rotation of the wheel 340. The fastener 342 can extend through the wheel 340 and the supports 452 to couple the drawing device 410 to the wheel 340. For example, a first and second end of the fastener 342 can protrude out of the supports 452. In some implementations, the fastener 342 can extend through the first and second ears 345, 346 of the support 344, the wheel 340, and the supports 452 of the drawing device 410 to couple the ears 345, 346, the wheel 340, and the supports 452 together. The supports 452 can be positioned inside (e.g., inward of) the first and second ears 345, 346. Alternatively, in some implementations, the supports 452 can be positioned outside (e.g., outward of) the first and second ears 345, 346.

The drawing device 410 can include a receptacle 422 (e.g., dispenser, marking device holder, lateral portion, holding portion) which can include any of the features and/or functionalities described with respect to any of the other receptacles described herein, for example, the receptacles 322, 324. For example, the receptacle 422 can be shaped and/or sized to receive (e.g., hold, retain, position) the marker 318.

The receptacle 422 can be positioned partially or substantially rearward of the wheel 340. The receptacle 422 can position at least a portion of the marker 318 (e.g., a distal or rear end of the marker 318) rearward of the wheel 340 such that the wheel 340 does not contact and/or smudge the markings left by the marker 318 as the vehicle 300 moves forward.

In some implementations, the receptacle 422 can be positioned (and/or can position the marker 318) in line with the wheel 340 (e.g., along the longitudinal axis LA of the wheel assembly 406). Positioning the marker 318 in line with the wheel 340 may avoid creating unequal amounts of drag on axial sides of the wheel 340.

The receptacle 422 can include a channel 428 (e.g., cavity, pocket, slot) shaped and sized to receive at least a portion (e.g., a first, proximal or front end) of the marker 318. In some implementations, the channel 428 can be partially or substantially cylindrical in shape. The channel 428 can include any of the features and/or functionalities described with respect to any of the other channels described herein, for example, the channels 328.

The drawing device 410 can include one or more marker biasing members 434 (e.g., springs, torsion springs, coil springs, elastomeric material, etc.) which can include any of the features and/or functionalities described with respect to any of the other marker biasing members described herein, for example, the marker biasing members 334. For example, the marker biasing member 434 can be positioned within the receptacle 422 (e.g., a proximal or upper end of the receptacle 422). The marker biasing member 434 can bias (e.g., move) the marker 318 toward the riding surface. The biasing member 434 can exert a biasing force along the longitudinal axis of the channel 428 (e.g., in the direction of an open end of the channel 428, in the direction of the longitudinal axis of the marker 318) which can be oriented at least partially in the direction of the riding surface.

In some implementations, the marker biasing member 434 does not directly contact and/or surround the marker 318. For example, the drawing device 410 can include a sleeve 460 disposed between the marker 318 and the marker biasing member 434 (e.g., within the channel 428 of the receptacle 422). The sleeve 460 can be shaped and/or sized to surround a first (e.g., proximal, front, upper) end of the marker 318. For example, the sleeve 460 can be partially or substantially cylindrical in shape. In some implementations, the marker 318 can be friction fit within the sleeve 460. In some implementations, the sleeve 460 can be formed of a flexible material such that the sleeve 460 can flex (e.g., inward and/or outward) to hold (e.g., conform to) markers 318 of different shapes and/or sizes. The marker biasing member 434 can bias (e.g., move) the sleeve 460 and the marker 318 toward the riding surface. For example, a biasing force exerted by the marker biasing member 434 can bias (e.g., translate) the sleeve 460 and the thus the marker 318 toward the open end of the receptacle 422. In some implementations, the sleeve 460 is inhibited or prevented from being removed from the receptacle 422.

In some implementations, the drawing device 410 does not rotate about the rotational axis RA of the wheel 340 to transition between the stowed and deployed positions. For example, the drawing device 410 can be partially or substantially prevented from rotating (e.g., upward and/or downward) about the rotational axis RA of the wheel 340. In some implementations, a top surface of the drawing device 410 can contact the support 344 when the drawing device 410 is rotated upward to physically inhibit or prevent substantial rotation of the drawing device 410 (and thus the coupled marker 318) away from the riding surface. This may increase the consistency of contact between the marker 318 and the riding surface, for example, by inhibiting or preventing the riding surface from forcing (e.g., bouncing) the marker 318 away from the riding surface. In some variants, a top surface of the drawing device 410 can contact the support 344 when the drawing device 410 is rotated downward to physically inhibit or prevent substantial rotation of the drawing device 410 (and thus the coupled marker 318) toward the riding surface. This may inhibit or prevent the drawing device 410 (e.g., the receptacle 422 and/or the supports 452) from physically contacting the riding surface. Physically inhibiting or preventing rotation of the drawing device 410 about the rotation axis RA (e.g., away from and/or toward the riding surface) may decrease the risk or breakage and/or wear on the drawing device 410 and the fastener 342 (e.g., axle), for example, due to repeated rotation of the drawing device 410 about the fastener 342.

In some implementations, the drawing device 410 can include an actuator 462 (e.g., pin, lever, handle, knob, etc.) which can be actuated (e.g., lifted, lowered) by a user to transition the drawing device 410 between the deployed and stowed positions. The actuator 462 can be coupled to the sleeve 460 such that movement of the actuator 462 causes a corresponding movement of the sleeve 460 (and thus the marker 318 received in the sleeve 460). A user can move the actuator 462 downward to move the marker 318 downward and transition the drawing device 410 to the deployed position in the which the marker 318 can contact the riding surface. Similarly, a user can move the actuator 462 upward to move the marker 318 upward and transition the drawing device 410 to the stowed position in which the marker does not contact the riding surface.

In some implementations, the actuator 462 can be disposed at least partially in a slot 464 of the drawing device 410. The slot 464 can be disposed at a rear end of the drawing device 410, for example, along a rear end of the receptacle 422. The slot 464 can be disposed along a longitudinal axis of the receptacle 422. For example, the slot 464 can be linear. The slot 464 can extend through the receptacle 422 (e.g., into the channel 428). In some implementations, the actuator 462 can extend through the slot 464 such that at least a portion of the actuator 462 extends beyond the slot 464 and/or the receptacle 422. This may allow a user to more easily interact with the actuator 462 to transition the drawing device 410 between the stowed and deployed positions. The slot 464 may guide and/or limit the direction of movement of the actuator 462 (and thus the sleeve 460 and marker 318). For example, the slot 464 may limit the actuator 462 (and thus the marker 318) to movement along the longitudinal axis of the receptacle 422 (which can be oriented at least partially toward the riding surface).

In some implementations, the drawing device 410 can include a locking mechanism to selectively retain the drawing device 410 in the stowed position. For example, the drawing device 410 can include a locking mechanism to selectively inhibit or prevent the biasing member 434 from moving the marker 318 toward the riding surface (e.g., by inhibiting or preventing expansion of the biasing member 434). In some implementations, the drawing device 410 can include a locking slot 466 which can be positioned proximate a top end of the slot 464. The locking slot 466 can be generally perpendicular to the slot 464. For example, as illustrated in FIG. 13, the slot 464 can be substantially vertical and the locking slot 466 can be substantially horizontal. In some implementations, the locking slot 466 can form a portion of the slot 464 such that the slots 464, 466 form one continuous slot along which the actuator 462 can travel. When the actuator 462 is positioned in the locking slot 466, (vertical) movement of the actuator 462 along the slot 464 can be inhibited or prevented, thereby maintaining the drawing device 410 in the stowed position by inhibiting or preventing the biasing member 434 from expanding and moving the marker 318 toward the riding surface.

In operation, when a user desires to transition the drawing device 410 to the stowed position, the user can move the actuator 462 upward along the slot 464 until the actuator 462 is positioned proximate the locking slot 466. The user can then move the actuator 462 (e.g., horizontally) into the locking slot 466 such that vertical movement of the actuator 462 and thus the biasing member 434, sleeve 460, and marker 318 (e.g., along the longitudinal axis of the receptacle) is inhibited or prevented. When a user desires to transition the drawing device 410 to the deployed position, the user can move the actuator 462 (e.g., horizontally) out of the locking slot 466, thereby allowing the biasing member 434 to expand and move the sleeve 460 and marker 318 toward the riding surface. In various embodiments, when the actuator 462 is in the slot 464, the marker 318 is automatically moved toward the riding surface, such as by the biasing member 434.

### E. Additional Example Drawing Devices

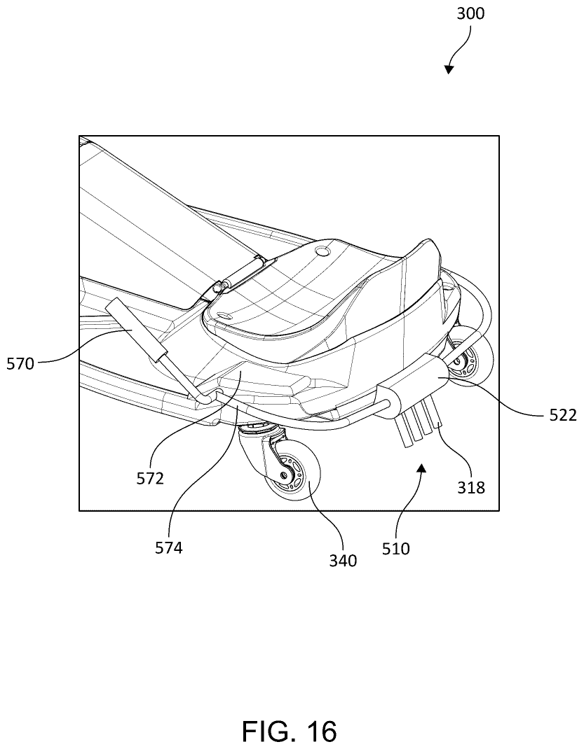

FIG. 16 illustrates a rear perspective view of a rearward portion of the vehicle 300 including a drawing device 510 which can include any of the features and/or functionalities described with respect to any of the other drawing devices described herein, for example, the drawing devices 110, 112, 210, 310, 312, 410. The drawing device 510 can be utilized in any of the vehicles described herein (e.g., vehicles 100, 200, 300) or any other vehicle.

The drawing device 510 can include at least an actuator 570 (e.g., lever, handle, pivot bar), a pivot support 572 (e.g., block), a linkage 574 (e.g., rod, bar), and/or a receptacle 522. As shown, the receptacle 522 can hold one or more markers 318.

The actuator 570 can be positioned proximate the seat 302 of the vehicle 300 such that a user can easily manipulate the actuator 570 while operating the vehicle 300. For example, the actuator 570 can be on a lateral side of and/or forward of the seat. As shown, the actuator 570 can be laterally outward of and/or forward of the rear caster wheel(s).

The actuator 570 can be rotated (e.g., pivoted) to transition the drawing device 510 between the stowed position (in which the marker(s) 318 do not contact a riding surface) and the deployed position (in which the marker(s) 318 can contact the riding surface to generate markings). For example, the actuator 570 can be rotated in a first direction (e.g., upward, clockwise in the view of FIG. 16) to transition the drawing device 510 toward the deployed position and/or the actuator 570 can be rotated in a second, opposite direction (e.g., downward, counterclockwise in the view of FIG. 16) to transition the drawing device 510 toward the stowed position. A user can rotate the actuator 570 by pushing and/or pulling on the actuator 570. The drawing device 510 can allow a user to selectively choose to mark or not mark during riding (e.g., during a drift) and/or without needing to access the wheel 340.

In some aspects, the actuator 570 can be rotatably (e.g., pivotably) coupled to the pivot support 572. The pivot support 572 can be coupled (e.g., permanently coupled) to the vehicle 300 (e.g., the body 301) to couple the actuator 570 to the vehicle 300 (e.g., the body 301 of the vehicle 300).

The linkage 574 can be coupled to the actuator 570 such that the linkage 574 rotates with the actuator 570. The linkage 574 can be positioned partially or substantially opposite the actuator 570 (e.g., relative to the rotational axis about which the actuator 570 and linkage 574 rotate) such that when the actuator 570 is pivoted upward, the linkage 574 is pivoted downward and vice versa. The linkage 574 can be coupled to the receptacle 522 such that the receptacle 522 moves (e.g., rotates, pivots) with the linkage 574. The linkage 574 can extend from the actuator 570 proximate a first lateral side of the vehicle 300 to the receptacle 522. In some implementations, the linkage 574 can extend from the receptacle 522 to a second lateral side of the vehicle opposite the first lateral side. The linkage 574 can couple to the second lateral side of the vehicle 300 (e.g., the body 301) which may increase the stability of the linkage 574 and thus the receptacle 522.

The receptacle 522 can receive and/or position one or more markers 318 and can include any of the features and/or functionalities described with respect to any of the other receptacles described herein. The receptacle 522 can orient the markers 318 at least partially toward the riding surface such that, when the receptacle 522 is rotated (e.g., pivoted) toward the riding surface (e.g., downward), the markers 318 can contact and generate markings on the riding surface. In some implementations, the receptacle 522 is not coupled to and/or does not contact the vehicle 300 (e.g., the body 301) such that the receptacle 522 can move (e.g., rotate) relative to the vehicle 300. The receptacle 522 can be positioned on a rear end of the vehicle 300 (e.g., rearward of the vehicle 300). In some implementations, the receptacle 522 can be positioned on or near a lateral midpoint of the vehicle 300.

In operation, when a user wishes to create markings, the user can rotate (e.g., pivot) the actuator 570 in the first direction to rotate (e.g., pivot) the linkage 574, the receptacle 522, and the markers 318 toward the riding surface to the deployed position. For example, in the implementation shown, the user pulls the actuator 570 upward for marking. The user can hold the actuator 570 up to continue marking. Varying the amount of pulling force can vary the force with which the marker 318 is pushed against the riding surface and thus vary the intensity of the marking (e.g., how much chalk is rubbed off). Certain implementations include a lock to maintain the actuator in the marking (e.g., up) position so the user does not need to hold the actuator 570 in position. When a user does not wish to create markings, the user can rotate (e.g., pivot) the actuator 570 in the second direction to rotate (e.g., pivot) the linkage 574, the receptacle 522, and the markers 318 away from the riding surface to the stowed position. For example, in the embodiment shown, the user pushes the actuator 570 downward for no marking. The drawing device 510 can be configured to stay in and/or be biased toward the non-marking position, such as with a latch or by gravity. For example, a weight of the actuator 570 can be greater than a combined weight of the linkage 574, receptacle 522, and marker(s), thereby automatically biasing the drawing device 510 to the non-marking position.

FIG. 17 illustrates a side view of the vehicle 300 including a drawing device 610 which can include any of the features and/or functionalities described with respect to any of the other drawing devices described herein, for example, the drawing devices 110, 112, 210, 310, 312, 410, 510. The drawing device 610 can be utilized in any of the vehicles described herein (e.g., vehicles 100, 200, 300) or any other vehicle.

The drawing device 610 can include at least an actuator 670 (e.g., lever, handle, pivot bar), a pivot member 642 (e.g., pin, rod, axle, etc.), and/or a receptacle 622. The actuator 670 can be positioned proximate a lateral side of the vehicle 300 such that a user can easily manipulate the actuator 670 while operating the vehicle 300. The actuator 670 can be positioned forward of a longitudinal midpoint of the vehicle 300 and/or closer to a steering handle (e.g., steering wheel) of the vehicle 300 than to a seat of the vehicle.

The actuator 670 can be rotated (e.g., pivoted) to transition the drawing device 610 between the stowed position (in which the marker(s) 318 do not contact a riding surface) and the deployed position (in which the marker(s) 318 can contact the riding surface to generate markings). For example, the actuator 670 can be rotated in a first direction (e.g., upward, clockwise in the view of FIG. 17) to transition the drawing device 610 toward the deployed position and/or the actuator 670 can be rotated in a second, opposite direction (e.g., downward, counterclockwise in the view of FIG. 17) to transition the drawing device 610 toward the stowed position. A user can rotate the actuator 670 by pushing and/or pulling on the actuator 670. In some aspects, the actuator 670 can be rotatably (e.g., pivotably) coupled to the pivot member 642 such that the actuator 670 rotates about the pivot member 642. The pivot member 642 can be coupled (e.g., permanently coupled) to the vehicle 300 (e.g., the body 301) to couple the actuator 670 to the vehicle 300 (e.g., the body 301 of the vehicle 300). In some aspects, the pivot member 642 can be coupled to an underside of the vehicle 300.

The receptacle 622 can be coupled to the actuator 670 and/or the pivot member 642 such that the receptacle 622 rotates with the actuator 670. The linkage 674 can be positioned partially or substantially opposite the actuator 670 (e.g., relative to the pivot member 642) such that when the actuator 670 is pivoted upward, the receptacle 622 is pivoted downward and vice versa. The receptacle 622 can receive and/or position one or more markers 318 and can include any of the features and/or functionalities described with respect to any of the other receptacles described herein. In some embodiments, the receptacle 622 can be positioned and/or can position the marker(s) 318 underneath the vehicle. In some implementations, the receptacle 622 can be positioned on or proximate the longitudinal midpoint of the vehicle 300. In some aspects, the receptacle 622 can be laterally offset from the wheels 340 such that the wheels 340 do not contact and/or smudge the markings left by the marker(s) 318.

In operation, when a user wishes to create markings, the user can rotate (e.g., pivot) the actuator 670 in the first direction to rotate (e.g., pivot) the receptacle 622 and the marker(s) 318 toward the riding surface to the deployed position. Conversely, when a user does not wish to create markings, the user can rotate (e.g., pivot) the actuator 670 in the second direction to rotate (e.g., pivot) the receptacle 622, and the marker(s) 318 away from the riding surface to the stowed position. In some implementations, the receptacle 622 and/or the marker(s) 318 can be partially or substantially horizontal when in the stowed position. In some implementations, the receptacle 622 and/or the marker(s) 318 can be partially or substantially flush with an underside of the vehicle 300 when in the stowed position.

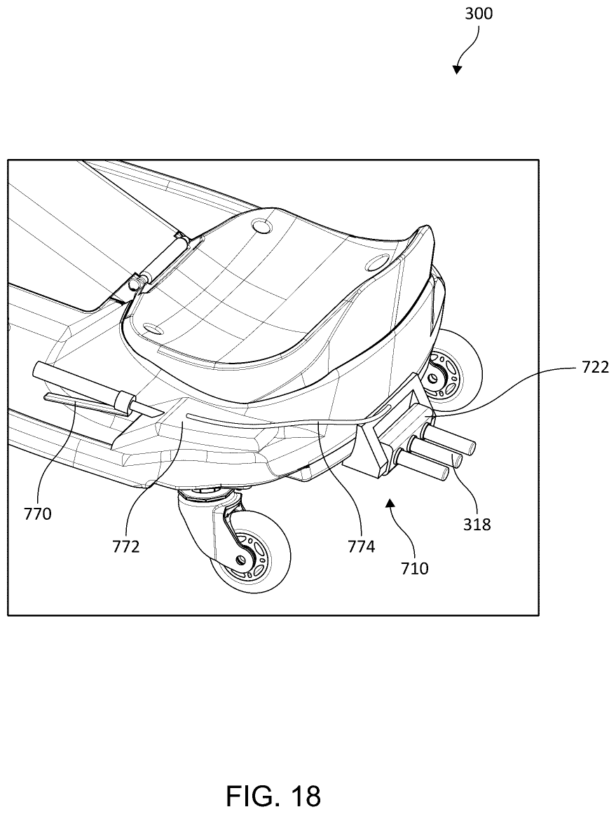

FIG. 18 illustrates a rear perspective view of a rearward portion of the vehicle 300 including a drawing device 710 which can include any of the features and/or functionalities described with respect to any of the other drawing devices described herein, for example, the drawing devices 110, 112, 210, 310, 312, 410, 510, 610. The drawing device 710 can be utilized in any of the vehicles described herein (e.g., vehicles 100, 200, 300) or any other vehicle.

The drawing device 710 can include at least an actuator 770 (e.g., lever, handle), a cable 774 (e.g., cord, wire, etc.), and/or a receptacle 722. The actuator 770 can be positioned proximate the seat 302 of the vehicle 300 such that a user can easily manipulate the actuator 770 while operating the vehicle 300. The actuator 770 can be pivotable and/or slidably coupled to a base 772 on the body of the vehicle 300.

The actuator 770 can be rotated (e.g., pivoted, squeezed) to transition the drawing device 710 between the stowed position (in which the marker(s) 318 do not contact a riding surface) and the deployed position (in which the marker(s) 318 can contact the riding surface to generate markings). For example, the actuator 770 can be rotated in a first direction (e.g., upward, clockwise in the view of FIG. 18) to transition the drawing device 710 toward the deployed position and/or the actuator 770 can be rotated in a second, opposite direction (e.g., downward, counterclockwise in the view of FIG. 18) to transition the drawing device 710 toward the stowed position. A user can rotate the actuator 770 in the first direction by squeezing the actuator 770. A user can rotate the actuator 770 in the second direction by releasing the actuator 770. In some implementations, the actuator 770 can be biased by one or more biasing elements toward the second direction.

The cable 774 can transmit the rotational movement of the actuator 770 to the receptacle 722. For example, the cable 774 can be coupled (e.g., directly or indirectly) to the actuator 770 and/or the receptacle 722. In some implementations, the actuator 770 and receptacle 722 are directly mechanically connected by the cable 774, such that movement of the actuator 770 moves the cable 774 which in turn moves the receptacle 722. In some implementations, the actuator 770 and receptacle 722 are otherwise connected. For example, in some variants, a sensor (not shown) detects movement of the actuator 770 and sends a signal to an electronic controller which in turn commands an electric motor to move the receptacle 722.

The receptacle 722 can receive and/or position one or more markers 318 and can include any of the features and/or functionalities described with respect to any of the other receptacles described herein. In some implementations, the receptacle 722 is free to rotate relative to the vehicle 300. The receptacle 722 can be positioned proximate a rear end of the vehicle 300 (e.g., rearward of the vehicle 300). In some implementations, the receptacle 722 can be positioned on or proximate a lateral midpoint of the vehicle 300.

In operation, when a user wishes to create markings, the user can rotate (e.g., pivot) the actuator 770 in the first direction, for example, by squeezing the actuator 770. Rotating the actuator 770 in the first direction can tension the cable 774 which can rotate the receptacle 722 downward toward the riding surface to the deployed position. Conversely, when a user does not wish to create markings, the user can rotate (e.g., pivot) the actuator 770 in the second direction, for example, by releasing the actuator 770. Rotating the actuator 770 in the second direction can detension (e.g., decrease tension in) the cable 774 which can rotate the receptacle 722 upward away from the riding surface to the stowed position. In some aspects, the receptacle 722 can be biased upward toward the stowed position by one or more biasing elements.

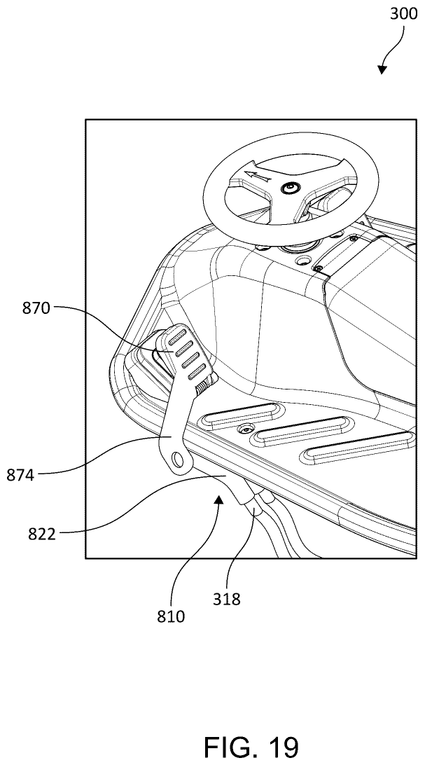

FIG. 19 illustrates a side perspective view of a forward portion of the vehicle 300 including a drawing device 810 which can include any of the features and/or functionalities described with respect to any of the other drawing devices described herein, for example, the drawing devices 110, 112, 210, 310, 312, 410, 510, 610, 710. The drawing device 810 can be utilized in any of the vehicles described herein (e.g., vehicles 100, 200, 300) or any other vehicle.

The drawing device 810 can include at least an actuator 870 (e.g., foot pedal), a linkage 874 (e.g., rod, bar), and/or a receptacle 822. The actuator 870 can be positioned proximate a front of the vehicle 300, for example, proximate a location where a user's foot would be positioned, such that a user can easily manipulate the actuator 870 with a foot while operating the vehicle 300.

The actuator 870 can be rotated (e.g., pivoted) to transition the drawing device 810 between the stowed position (in which the marker(s) 318 do not contact a riding surface) and the deployed position (in which the marker(s) 318 can contact the riding surface to generate markings). For example, the actuator 870 can be rotated in a first direction (e.g., upward, clockwise in the view of FIG. 16) to transition the drawing device 810 toward the stowed position and/or the actuator 870 can be rotated in a second, opposite direction (e.g., downward, counterclockwise in the view of FIG. 16) to transition the drawing device 810 toward the deployed position. A user can rotate the actuator 870 by pushing and/or pulling on the actuator 870 (e.g., with a foot). A user can rotate the actuator 870 in the second direction by pressing on the actuator 870. A user can rotate the actuator 870 in the first direction by releasing the actuator 870. In some implementations, the actuator 870 can be biased by one or more biasing elements toward the first direction. For example, in response to the user's foot being released from the actuator 870, marking can automatically stop.

The linkage 874 can be coupled to the actuator 870 such that the linkage 874 rotates with the actuator 870. The linkage 874 can be coupled to the receptacle 822 such that the receptacle 822 moves (e.g., rotates, pivots) opposite the linkage 874. For example, when the actuator 870 and/or the linkage 874 are rotated in the first direction, the receptacle 822 (and thus the marker 318) can rotate in the second direction and vice versa. The receptacle 822 can receive and/or position one or more markers 318 and can include any of the features and/or functionalities described with respect to any of the other receptacles described herein. The receptacle 822 can be positioned proximate a front end of the vehicle 300. In some implementations, the receptacle 822 can be offset from the wheels 340.

In operation, when a user wishes to create markings, the user can rotate (e.g., pivot) the actuator 870 in the second direction to rotate (e.g., pivot) the linkage 874, the receptacle 822, and the markers 318 toward the riding surface to the deployed position. Conversely, when a user does not wish to create markings, the user can rotate (e.g., pivot) the actuator 870 in the first direction, for example, by releasing the actuator 870. In some aspects, the receptacle 822 can be biased upward toward the stowed position by one or more biasing elements.

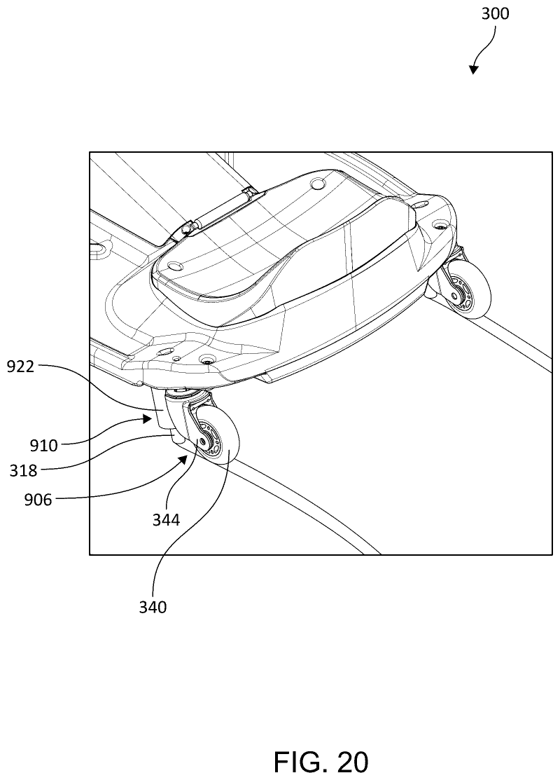

FIG. 20 illustrates a rear perspective view of a rearward portion of the vehicle 300 including a wheel assembly 906 which can include any of the features and/or functionalities described with respect to any of the other wheel assemblies described herein, for example, the wheel assemblies 106, 108, 206, 306, 308. For example, the wheel assembly 906 can include a drawing device 910 (e.g., drawing assembly, marking assembly, surface marking assembly, chalk dispenser) to selectively generate markings on a riding surface. The drawing device 910 can include any of the features and/or functionalities described with respect to any of the other drawing devices described herein, for example, the drawing devices 110, 112, 210, 310, 312. The wheel assembly 906 and/or the drawing device 910 can be utilized in any of the vehicles described herein (e.g., vehicles 100, 200, 300) or any other vehicle.

In some implementations, the drawing device 910 (e.g., the receptacle 922) can be integrally formed with a caster wheel. For example, the drawing device 910 (e.g., the receptacle 922) can be integrally formed with the wheel assembly 906 (e.g., a support 344). This may decrease the complexity of the wheel assembly 906 which may decrease cost and/or decrease the risk of breakage. In some implementations, the drawing device 910 is a separate component that is attached to the wheel assembly 906. In certain implementations, the drawing device 910 swivels as part of the wheel assembly 906. As illustrated, the receptacle 922 can be positioned forward of the wheel 340 such that the marker 318 generates markings forward of the wheel 340.

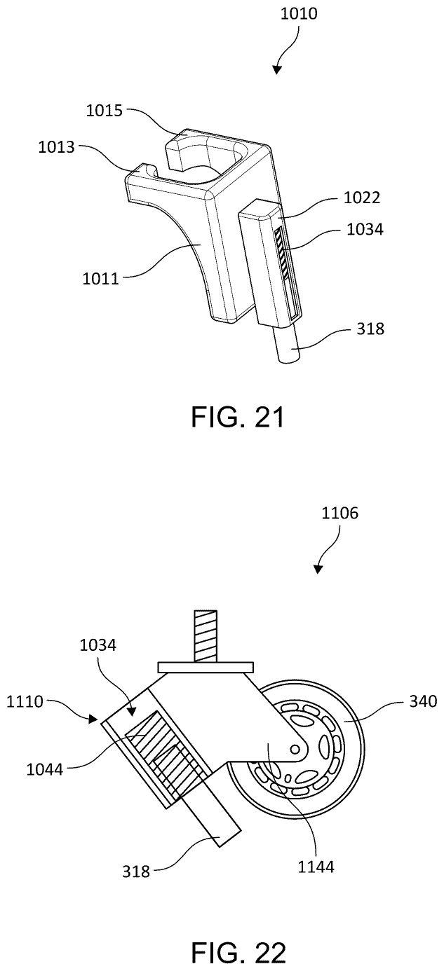

FIG. 21 illustrates a rear perspective view of a drawing device 1010 which can include any of features and/or functionalities described with respect to any of the other drawing devices described herein, for example, the drawing devices 110, 112, 210, 310, 312, 910. The drawing device 1010 can be utilized in any of the vehicles described herein (e.g., vehicles 100, 200, 300) or any other vehicle. The drawing device 1010 can include a receptacle 1022 and a biasing member 1034 which can include any of features and/or functionalities described with respect to any of the other receptacles and biasing members described herein. The drawing device 1010 can include a body 1011 (e.g., frame) which can position the receptacle 1022. The drawing device 1010 can permanently or removably couple to any of the wheel assemblies described herein when a user wishes to generate markings on the riding surface. For example, the drawing device 1010 can flexibly clip onto a caster wheel (e.g., the bearing and/or support of a caster wheel) which may allow a user to easily and/or quickly install or uninstall the drawing device 1010 when desired. The drawing device 1010 can include a first arm 1013 and a second arm 1015 which can removably clip onto (e.g., at least partially surround) a caster wheel (e.g., the bearing and/or support of a caster wheel). The arms 1013, 1015 can extend from a first (e.g., top) end of the body 1011. The arms 1013, 1015 can resiliently flex to connect or disconnect the drawing device 1010 to a wheel assembly, such as a caster wheel assembly. The arms 1013, 1015 can be positioned on opposite lateral sides of the body 1011. In some implementations, the drawing device 1010 can be positioned forward of the wheel 340 when coupled to avoid inhibiting rotation of the wheel 340.

FIG. 22 illustrates a side view of a wheel assembly 1106 including a drawing device 1110. The wheel assembly 1106 and the drawing device 1110 can include any of the features and/or functionalities described with respect to any of the other wheel assemblies and/or drawing devices described herein. The drawing device 1110 can include a receptacle 1122 and a biasing member 1134 which can include any of features and/or functionalities described with respect to any of the other receptacles and biasing members described herein. In some implementations, the drawing device 1110 (e.g., the receptacle 1122) can be integrally formed with a caster wheel. For example, the drawing device 1110 (e.g., the receptacle 1122) can be integrally formed with or attached to the wheel assembly 1106 (e.g., a support 1144 of the wheel assembly 1106). In some implementations, the receptacle 1122 can be positioned forward of the wheel 340 such that the marker 318 generates markings forward of the wheel 340. Positioning the receptacle 1122 and marker 318 forward of the wheel 340 may prevent or inhibit the drawing device 1110 from inhibiting rotation of the wheel 340. As shown, the drawing device 1110 can include a chamber 1044. A portion of the marker 318 can be received in the chamber 1044 and another portion of the marker 318 can protrude out of the chamber 1044 to mark on the riding surface. A biasing member (e.g., a spring) can hold and/or bias the marker 318 toward the riding surface.

### F. Certain Terminology

Certain terminology may be used in the following description for the purpose of reference only, and thus is not intended to be limiting. For example, terms such as “upper”, “lower”, “upward”, “downward”, “above”, “below”, “top”, “bottom”, “left”, and similar terms refer to directions in the drawings to which reference is made. Such terminology may include the words specifically mentioned above, derivatives thereof, and words of similar import. Similarly, the terms “first”, “second”, and other such numerical terms referring to structures neither imply a sequence or order unless clearly indicated by the context.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “spherical” or “circular” or “cylindrical” or “semi-circular” or “semi-cylindrical” or any related or similar terms, are not required to conform strictly to the mathematical definitions of spheres, circles, cylinders or other structures, but can encompass structures that are reasonably close approximations.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees. As another example, in certain embodiments, as the context may permit, the term “generally perpendicular” can refer to something that departs from exactly perpendicular by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Some embodiments have been described in connection with the accompanying drawings. The figures are drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### G. Summary

Various embodiments and examples of drawing devices and associated personal transportation vehicles and methods have been disclosed herein. Although the invention has been disclosed in the context of certain embodiments and examples, it will be understood by those skilled in the art that this disclosure extends beyond the specifically disclosed embodiments to other alternative embodiments and/or uses of the embodiments and certain modifications and equivalents thereof. For example, although certain examples are described and illustrated with the drawing device on a rear caster wheel, in some implementations the drawing device of any of the examples disclosed herein is on a front wheel and/or a non-caster wheel. The scope of the present disclosure is not intended to be limited by the specific disclosures of preferred embodiments in this section or elsewhere in this specification, and may be defined by claims as presented in this section or elsewhere in this specification or as presented in the future.

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope of the disclosure. Any feature from one embodiment can be included in any other embodiment. No element, feature, step, or aspect is critical or essential.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

In summary, various embodiments and examples of drawing devices and associated personal transportation vehicles and methods and methods have been disclosed. Although the devices, vehicles, and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described above, but should be determined only by a fair reading of the claims that follow.

The following is claimed:

1. A drifting cart comprising:
a body;
a seat on the body;
a steerable wheel on a front of the body;
a motor configured to drive the steerable wheel;
a first caster wheel assembly on a rear of the body, the first caster wheel assembly comprising:
a first fork;
a first rear wheel connected to the first fork, the first rear wheel configured to swivel about a first swivel axis and rotate about a first rotation axis;
a first chalk dispenser connected to the first fork; and
a first chalk stick partially received in the first chalk dispenser; and
a second caster wheel assembly on the rear of the body, the second caster wheel assembly comprising:
a second fork;
a second rear wheel connected to the second fork, the second rear wheel configured to swivel about a second swivel axis and rotate about a second rotation axis;
a second chalk dispenser connected to the second fork; and
a second chalk stick partially received in the second chalk dispenser;
the first and second chalk dispenser each configured to move between a stowed position and a deployed position and configured such that, during travel of the drifting cart on a riding surface with the first and second chalk dispensers in the deployed position, the first and second chalk sticks mark the riding surface.

2. The drifting cart of claim 1, wherein the first and second chalk dispensers are independently moveable between the stowed and deployed positions.

3. The drifting cart of claim 1, further comprising a latch configured to releasably retain the first chalk dispenser in the stowed position.

4. The drifting cart of claim 1, further comprising a spring configured to bias the first chalk dispenser toward the deployed position.

5. The drifting cart of claim 1, wherein, with the first chalk dispenser in the deployed position, a front end of the first chalk stick is forward of a rear edge of the first rear wheel and a rear end of the first chalk stick is rearward of the rear edge of the first rear wheel.

6. A personal mobility vehicle configured to mark a path on a riding surface, the personal mobility vehicle comprising:
a body configured to support a rider; and
a caster wheel assembly on a rear of the body, the caster wheel assembly comprising:
a wheel configured to swivel, relative to the body, about a swivel axis and to rotate, relative to the body, about a rotation axis, the rotation axis passing through an axial center of the wheel; and
a marker configured to swivel with the wheel and to mark the riding surface.

7. The personal mobility vehicle of claim 6, wherein the marker comprises a stick of chalk.

8. The personal mobility vehicle of claim 6, wherein the marker comprises a first mark element on a first axial side of the wheel and a second mark element on a second axial side of the wheel.

9. The personal mobility vehicle of claim 6, wherein the marker is further configured to rotate relative to the body and the wheel.

10. A caster wheel assembly comprising:
a mount;
a fork comprising a first ear and a second ear;
a bearing between the mount and the fork such that the fork can swivel relative to the mount;
a wheel;
a marker assembly comprising a first support, a second support, a body, and a dispenser, the dispenser configured to receive a front portion of a marker and to enable a rear portion of the marker to protrude from the dispenser; and
an axle that passes through the first and second ears of the fork, the wheel, and the first and second supports of the marker assembly;
wherein the marker assembly is configured to rotate, about the axle and relative to the wheel, between a stowed position and a deployed position.

11. The caster wheel assembly of claim 10, wherein a first end and a second end of the axle protrude out of the respective first and second supports of the marker assembly.

12. The caster wheel assembly of claim 10, wherein the first ear and the first support are on a first axial side of the wheel and the second ear and the second support are on a second axial side of the wheel.

13. The caster wheel assembly of claim 10, further comprising a latch configured to releasably retain the marker assembly in the stowed position.

14. The caster wheel assembly of claim 13, wherein the latch comprises a resilient arm positioned above the wheel.

15. The caster wheel assembly of claim 10, further comprising a spring configured to bias the marker assembly toward the deployed position.

16. The caster wheel assembly of claim 10, wherein the marker assembly further comprises a spring configured to bias the marker out of the dispenser.

17. The caster wheel assembly of claim 16, wherein the marker assembly further comprises a second dispenser, the dispenser on a first axial side of the wheel and the second dispenser on a second axial side of the wheel.

18. A combination comprising the caster wheel assembly of claim 10 and the marker.

19. A scooter comprising a handlebar assembly, a front wheel steerable by the handlebar assembly, a deck configured to support a user, a support connecting a front of the deck to the handlebar assembly, and the caster wheel assembly of claim 10 on a rear of the deck.

20. A drifting cart comprising a body, a seat connected to the body, a front having a powered steerable wheel, and a rear having a plurality of the caster wheel assemblies of claim 10.
